(19) United States
(12) Patent Application Publication
(10) Pub. No.: US 2025/0230523 A1
(43) Pub. Date: Jul. 17, 2025

(54) TIN PRODUCTION POWERED BY GEOTHERMAL ENERGY

(71) Applicant: EnhancedGEO Holdings, LLC, St. Petersburg, FL (US)

(72) Inventors: Kimberly C. Conner, Gouldsboro, ME (US); Greg Lindberg, Thonotosassa, FL (US)

(21) Appl. No.: 19/013,445

(22) Filed: Jan. 8, 2025

Related U.S. Application Data
(60) Provisional application No. 63/620,258, filed on Jan. 12, 2024.

(51) Int. Cl. C22B 25/02; C22B 4/04

(52) U.S. Cl. CPC C22B 25/02; C22B 4/04

(57) ABSTRACT

A geothermally powered tin production system includes a geothermal system with a wellbore extending from a surface into an underground magma reservoir. Geothermal energy powers systems and processes used to extract tin from a tin-containing starting material.

### RELATED APPLICATIONS

The present disclosure claims priority to U.S. Provisional Patent Application Ser. No. 63/620,258, filed Jan. 11, 2024, which is incorporated herein by reference in its entirety for all purposes.

### TECHNICAL FIELD

The present disclosure relates generally to metal extraction and more particularly to tin production powered by geothermal energy.

### BACKGROUND

Tin is produced by refinement through energy intensive processes involving heat and mechanical energy. Considerable energy is expended to supply heat and power the equipment used to perform such production. Renewable energy sources, such as solar power and wind power, can be unreliable and have relatively low power densities, such that they may be insufficient to reliably power tin production equipment. As such, production equipment typically relies on non-renewable fuels for power. There exists a need for improved tin production processes.

### SUMMARY

This disclosure recognizes the previously unidentified and unmet need for a reliable renewable energy source for tin production. This disclosure provides a solution to this unmet need in the form of a tin production system that is powered at least partially by geothermal energy. A geothermal system harnesses heat from a geothermal resource with a sufficiently high temperature for driving processes performed by a tin production system. For example, steam may be obtained from a geothermal system and used to heat one or more reactor vessels to obtain tin from an initial ore provided to the tin production system. For instance, heated fluid from a geothermal system may be used to heat a heat exchanger to maintain appropriate temperatures for reactions in a flotation tank. As another example, heated fluid may be used to heat a roaster to facilitate desired oxidation reactions. In some cases, one or more geothermally powered motors may be powered with steam from a geothermal system and used to support mechanical operations of the tin production process, such as to crush and grind tin-containing ores. As another example, the same or a different geothermally powered motor may power a pump and/or conveyor that is used to move materials between different process equipment for tin production. One or more turbines may be powered by the steam to provide electricity for any electronic components of the tin production system (e.g., electronic controllers, sensors, etc.).

In some embodiments, the geothermal system that powers the tin production system is a closed geothermal system that exchanges heat with an underground geothermal reservoir. The geothermal reservoir may be magma. For example, an underground geothermal reservoir, such as a magma reservoir, may facilitate the generation of high-temperature, high-pressure steam, while avoiding problems and limitations associated with previous geothermal technology. The geothermal systems of this disclosure generally include a wellbore that extends from a surface into an underground thermal reservoir, such as a magma. A closed heat-transfer loop is employed in which a heat transfer fluid is pumped into the wellbore, heated via contact with the underground thermal reservoir, and returned to the surface to power a tin production system located within a sufficient proximity to the wellbore.

The geothermal system of this disclosure may harness a geothermal resource with sufficiently high amounts of energy from magmatic activity such that the geothermal resource does not degrade significantly over time. This disclosure illustrates improved systems and methods for capturing energy from magma reservoirs, dikes, sills, and other magmatic formations that are significantly higher in temperature than heat sources that are accessed using previous geothermal technologies and that can contain an order of magnitude higher energy density than the geothermal fluids that power previous geothermal technologies. In some cases, the present disclosure can significantly decrease tin production costs and/or reliance on non-renewable resources for tin production system operations. In some cases, the present disclosure may facilitate more efficient tin production in regions where access to reliable power is currently unavailable or transport of non-renewable fuels is challenging. The systems and methods of the present disclosure may also or alternatively aid in decreasing carbon emissions.

Certain embodiments may include none, some, or all of the above technical advantages. One or more technical advantages may be readily apparent to one skilled in the art from figures, description, and claims included herein.

### BRIEF DESCRIPTION OF THE FIGURES

For a more complete understanding of the present disclosure, reference is now made to the following description, taken in conjunction with the accompanying drawings and detailed description, in which like reference numerals represent like parts.

FIG. 1 is a diagram of underground regions near a tectonic plate boundary in the Earth.

FIG. 2 is a diagram of a conventional geothermal system.

FIG. 3 is a diagram of an example improved geothermal system of this disclosure.

FIG. 4 is a diagram of an example system in which tin production is powered by the improved geothermal system of FIG. 3.

FIG. 5 is a diagram of an example geothermally powered hydrometallurgical tin production system that may be used as the tin production system of FIG. 4. The geothermally powered hydrometallurgical tin production system extracts tin-bearing materials from tin oxide ore using a hydrometallurgical process.

FIG. 6 is a flowchart of an example method for operating the hydrometallurgical system of FIG. 5.

FIG. 7 is a diagram of an example geothermally powered pyrometallurgical tin production system that may be used as the tin production system of FIG. 4. The system of FIG. 7 extracts tin-bearing materials from tin sulfide ore using a pyrometallurgical process.

FIG. 8 is a flowchart of an example method for operating the pyrometallurgical system of FIG. 7.

FIG. 9 is a diagram of an example geothermally powered tin refining system that may be used in the tin production system of FIG. 4. The system of FIG. 7 can refine the tin concentrate produced by the systems of FIG. 5 and/or the system of FIG. 7 or a tin concentrate obtained through another approach.

FIG. 10 is a flowchart of an example method for operating the tin refining system of FIG. 9.

FIG. 11 is a diagram of an example system for performing thermal processes of FIGS. 3 and 4.

FIG. 12 is a diagram of an example system for heating and cooling components of the systems of FIG. 5, FIG. 7, and FIG. 9 using heat transfer fluids and geothermal heating.

FIG. 13 is a diagram of an example temperature controller used to operate heating and cooling functions in FIG. 12.

FIG. 14 is a flowchart of an example method for operating the example temperature controller of FIG. 12.

### DETAILED DESCRIPTION

Embodiments of the present disclosure and its advantages will become apparent from the following detailed description when considered in conjunction with the accompanying figures. In the figures, each identical, or substantially similar component that is illustrated in various figures is represented by a single numeral or notation. For purposes of clarity, not every component is labeled in every figure, nor is every component of each embodiment shown where illustration is not necessary to allow those of ordinary skill in the art to understand the disclosure.

As used herein, “magma” refers to extremely hot liquid and semi-liquid rock under the Earth's surface. Magma is formed from molten or semi-molten rock mixture found typically between 1 km to 10 km under the surface of the Earth. As used herein, “borehole” refers to a hole that is drilled to aid in the exploration and recovery of natural resources, including oil, gas, water, or heat from below the surface of the Earth. As used herein, a “wellbore” refers to a borehole either alone or in combination with one or more other components disposed within or in connection with the borehole in order to perform exploration and/or recovery processes. In some cases, the terms “wellbore” and “borehole” are used interchangeably. As used herein, “heat transfer fluid” refers to a fluid, e.g., a gas or liquid, that takes part in heat transfer by serving as an intermediary in cooling on one side of a process, transporting and storing thermal energy, and heating on another side of a process. Heat transfer fluids are used in processes requiring heating or cooling.

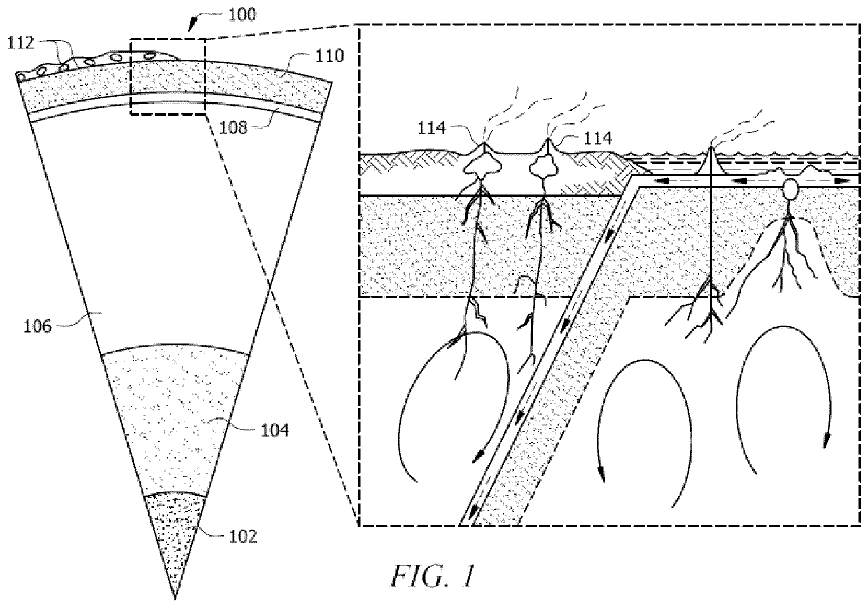

FIG. 1 is a partial cross-sectional diagram of the Earth depicting underground formations that can be tapped by geothermal systems of this disclosure (e.g., for generating geothermal power). The Earth is composed of an inner core 102, outer core 104, lower mantle 106, transition zone 108, upper mantle 110, and crust 112. There are places on the Earth where magma reaches the surface of the crust 112 forming volcanoes 114. However, in most cases, magma approaches only within a few miles or less from the surface. This magma can heat ground water to temperatures sufficient for certain geothermal power production. However, for other applications, such as geothermal energy production, more direct heat transfer with the magma is desirable.

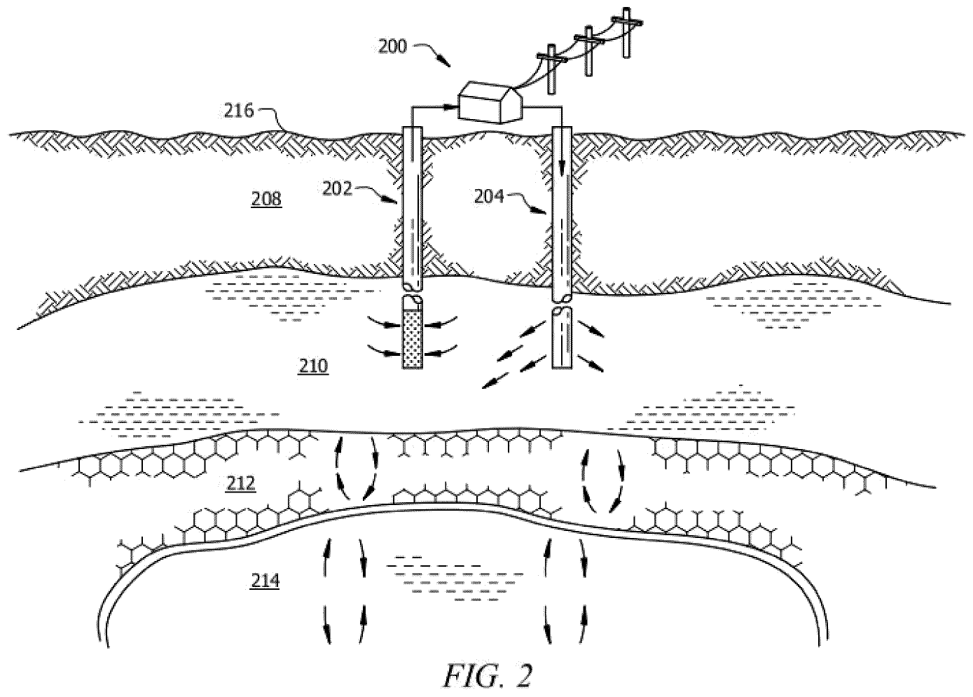

FIG. 2 illustrates a conventional geothermal system 200 that harnesses energy from heated ground water for power generation. The conventional geothermal system 200 is a “flash-plant” that generates power from a high-temperature, high-pressure geothermal water extracted from a production well 202. The production well 202 is drilled through rock layer 208 and into the geothermal fluid layer 210 that serves as the source of geothermal water. The geothermal water is heated indirectly via heat transfer with intermediate layer 212, which is in turn heated by magma reservoir 214. Convective heat transfer (illustrated by the arrows indicating that hotter fluids rise to the upper portions of their respective layers before cooling and sinking, then rising again) may facilitate heat transfer between these layers. Geothermal water from the geothermal fluid layer 210 flows to the surface 216 and is used for geothermal power generation. The geothermal water (and possibly additional water or other fluids) is then injected back into the geothermal fluid layer 210 via an injection well 204.

The configuration of conventional geothermal system 200 of FIG. 2 suffers from drawbacks and disadvantages, as recognized by this disclosure. For example, the system 200 may not achieve sufficiently high temperatures to facilitate efficient tin production. As another example, because geothermal water is a polyphase mixture (i.e., not pure water), the geothermal water flashes at various points along its path up to the surface 216, creating water hammer, which results in a large amount of noise and potential damage to system components. The geothermal water is also prone to causing scaling and corrosion of system components. Chemicals may be added to partially mitigate these issues, but this may result in considerable increases in operational costs and increased environmental impacts, since these chemicals are generally introduced into the environment via injection well 204.

### Example Improved Geothermal System

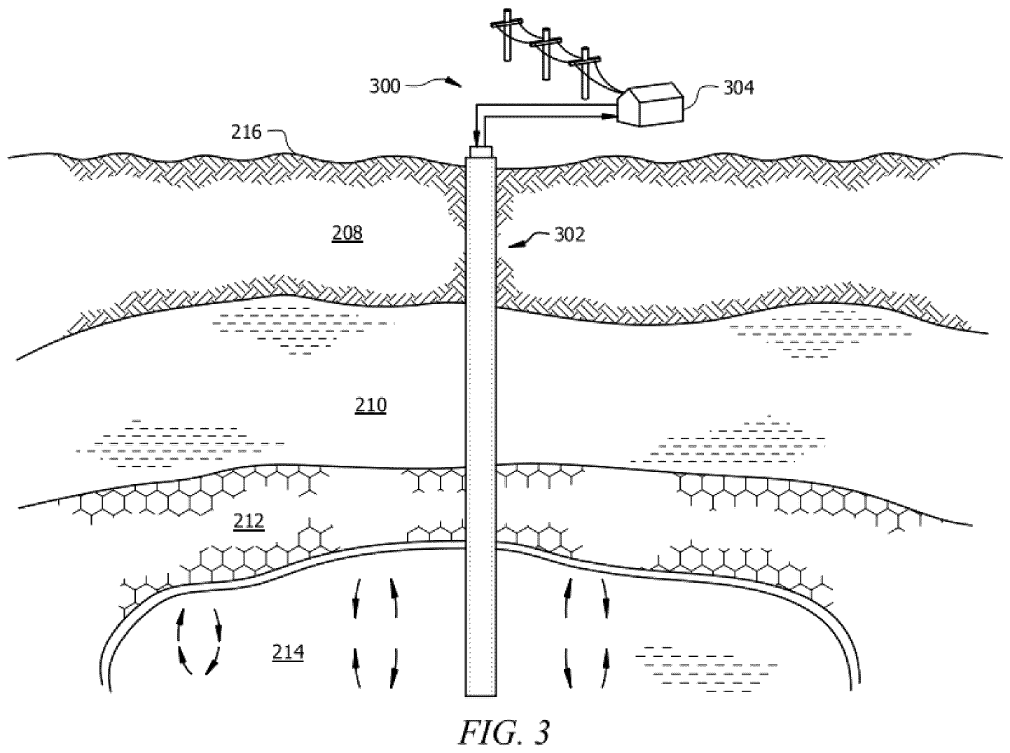

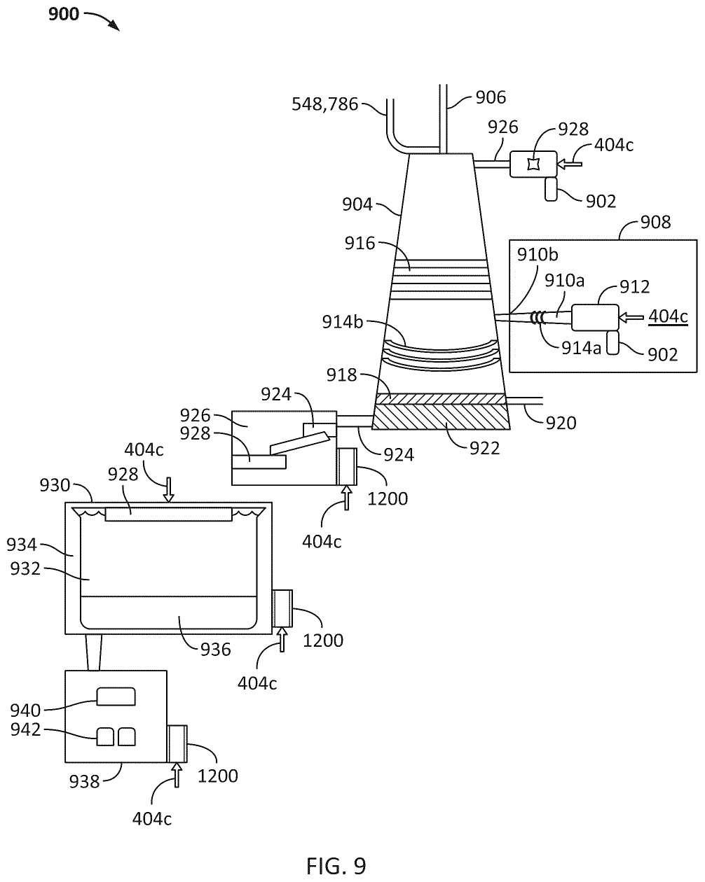

FIG. 3 illustrates an example magma-based geothermal system 300 of this disclosure. The magma-based geothermal system 300 includes a wellbore 302 that extends from the surface 216 at least partially into the magma reservoir 214. The magma-based geothermal system 300 is a closed system in which a heat transfer fluid is provided down the wellbore 302 to be heated and returned to a thermal process system 304 (e.g., for power generation and/or any other thermal processes of interest). As such, geothermal water is not extracted from the Earth, resulting in significantly reduced risks associated with the conventional geothermal system 200 of FIG. 2, as described further below. Heated heat transfer fluid is provided to the thermal process system 304. The thermal process system 304 is generally any system that uses the heat transfer fluid to drive a process of interest. For example, the thermal process system 304 may include an electricity generation system and/or support thermal processes requiring higher temperatures/pressures than could be reliably or efficiently obtained using previous geothermal technology, such as the conventional geothermal system 200 of FIG. 2. Further details of components of an example thermal process system 304 are provided with respect to FIG. 9 below.

The magma-based geothermal system 300 provides technical advantages over previous geothermal systems, such as the conventional geothermal system 200 of FIG. 2. The magma-based geothermal system 300 can achieve higher temperatures and pressures for increased energy generation (and/or for more effectively driving other thermal processes). For example, because of the high energy density of magma in magma reservoir 214 (e.g., compared to that of geothermal water of the geothermal fluid layer 210), wellbore 302 can generally create the power of many wells of the conventional geothermal system 200 of FIG. 2. Furthermore, the magma-based geothermal system 300 has little or no risk of thermal shock-induced earthquakes, which might be attributed to the injection of cooler water into a hot geothermal zone, as is performed using the conventional geothermal system 200 of FIG. 2. The heat transfer fluid is generally not substantially released into the geothermal zone, resulting in a decreased environmental impact and decreased use of costly materials (e.g., chemical additives that are used and introduced to the environment in great quantities during some conventional geothermal operations). The magma-based geothermal system 300 may also have a simplified design and operation compared to those of previous systems. For instance, fewer components and reduced complexity may be needed at the thermal process system 304 because only clean heat transfer fluid (e.g., steam) reaches the surface 216. There may be no need or a reduced need to separate out solids or other impurities that are common to geothermal water. The example magma-based geothermal system 300 may include further components not illustrated in FIG. 3.

Further details and examples of different configurations of geothermal systems and methods of their preparation and operation are described in U.S. patent application Ser. No. 18/099,499, filed Jan. 20, 2023, and titled “Geothermal Power from Superhot Geothermal Fluid and Magma Reservoirs”; U.S. patent application Ser. No. 18/099,509, filed Jan. 20, 2023, and titled “Geothermal Power from Superhot Geothermal Fluid and Magma Reservoirs”; U.S. patent application Ser. No. 18/099,514, filed Jan. 20, 2023, and titled “Geothermal Power from Superhot Geothermal Fluid and Magma Reservoirs”; U.S. patent application Ser. No. 18/099,518, filed Jan. 20, 2023, and titled “Geothermal Power from Superhot Geothermal Fluid and Magma Reservoirs”; U.S. patent application Ser. No. 18/105,674, filed Feb. 3, 2023, and titled “Wellbore for Extracting Heat from Magma Chambers”; U.S. patent application Ser. No. 18/116,693, filed Mar. 2, 2023, and titled “Geothermal systems and methods with an underground magma chamber”; U.S. patent application Ser. No. 18/116,697, filed Mar. 2, 2023, and titled “Method and system for preparing a geothermal system with a magma chamber”; and U.S. Provisional Patent Application No. 63/444,703, filed Feb. 10, 2023, and titled “Geothermal systems and methods using energy from underground magma reservoirs”, the entirety of each of which is hereby incorporated by reference.

### Geothermally Powered Tin Production

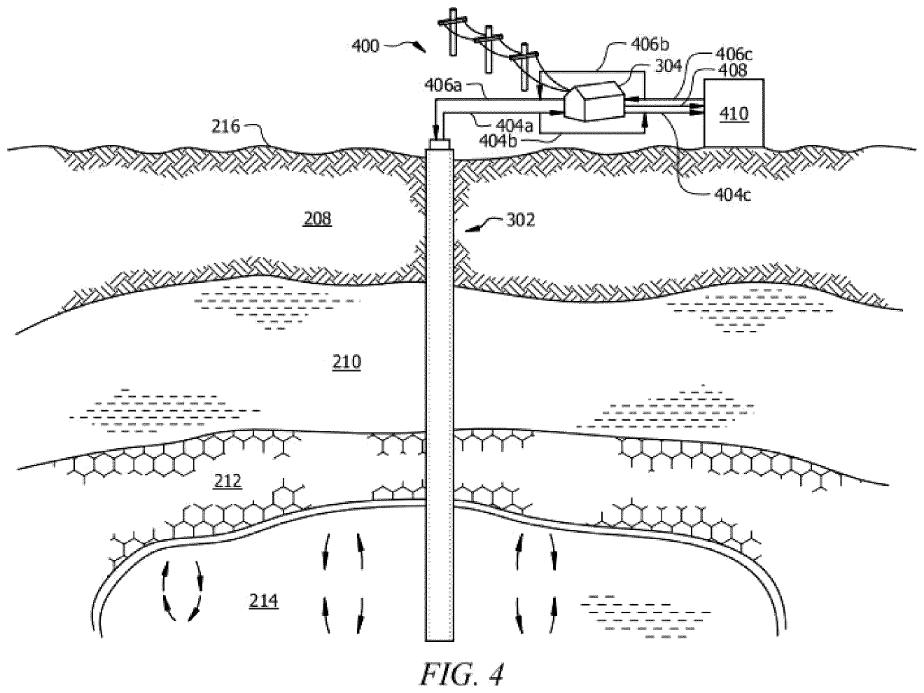

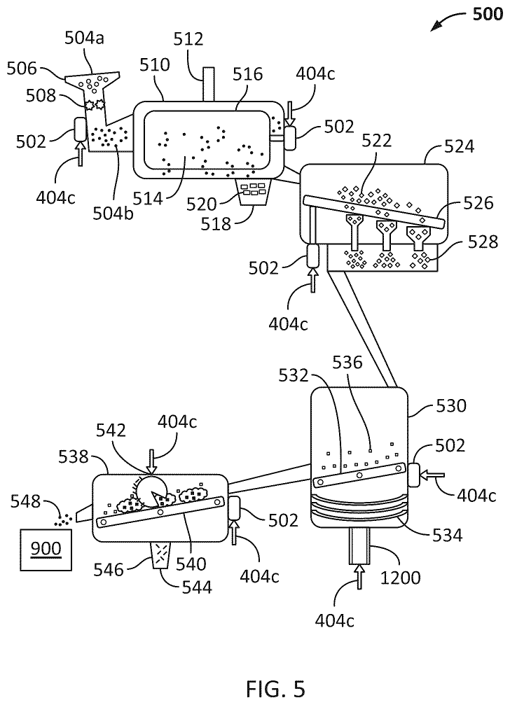

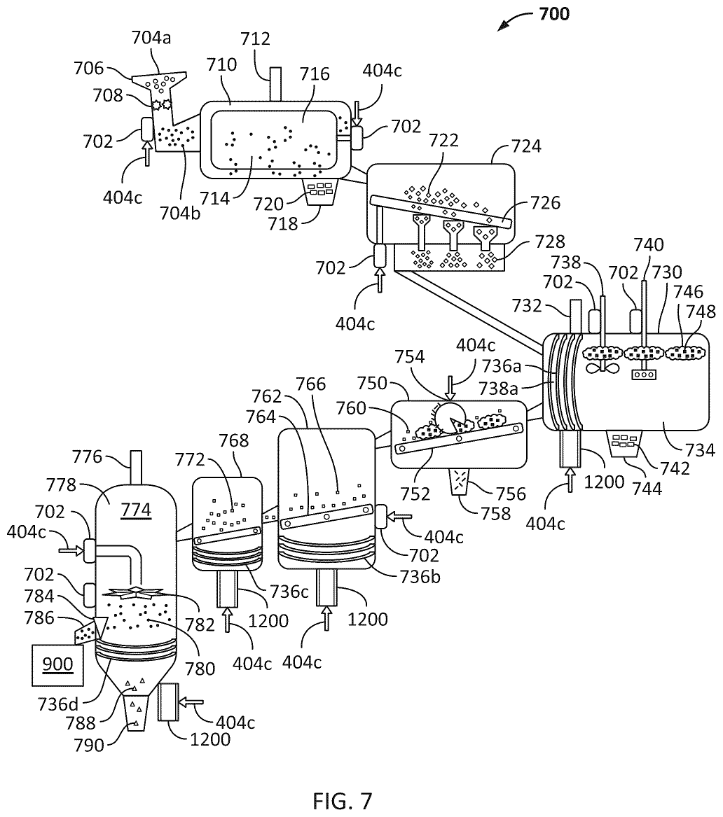

FIG. 4 illustrates an example combined geothermal and tin production system 400 of this disclosure. The combined geothermal and tin production system 400 includes all or a portion of the components of the magma-based geothermal system 300 described above with respect to FIG. 3 as well as geothermally powered tin production system 410. The geothermally powered tin production system 410 may include a geothermally powered hydrometallurgical tin extraction system (e.g., system 500 of FIG. 5) for producing tin concentrate using hydrometallurgical methods and/or a geothermally powered pyrometallurgical tin extraction system (e.g., system 700 of FIG. 7) for producing tin concentrate using pyrometallurgical methods. The geothermally powered tin production system 410 may include a geothermally powered tin refining system (e.g., system 900 of FIG. 9) for producing tin. The combined geothermal and tin production system 400 may include all or a portion of the thermal process system 304.

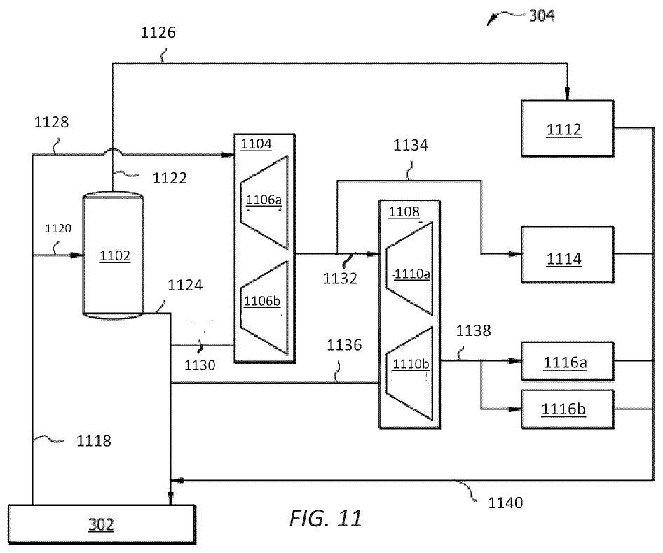

In operation, heat transfer fluid is injected into the wellbore 302, which extends from the surface 216 into the magma reservoir 214 underground. The heated heat transfer fluid can be conveyed to the thermal process system 304 as heat transfer fluid 404a that can be used to drive processes, such as the generation of electricity 408 by turbines 1104 and 1108 in FIG. 11. Heat transfer fluid 404a may be referred to in the alternative as a stream of heat transfer fluid 404a. Heat transfer fluid 404c, which can be formed from any remaining amount of heat transfer fluid 404a (e.g., steam) exiting from the thermal process system 304 and/or the wellbore bypass stream, i.e., heat transfer fluid 404b, is provided to the geothermally powered tin production system 410. The electricity 408 may be used in addition to or in place of heat transfer fluid 404c for powering electrical and mechanical processes in the geothermally powered tin production system 410.

As described in greater detail below with respect to FIGS. 5 and 7, the geothermally powered tin production system 410 can use the heat transfer fluid 404c to drive hydrometallurgical and/or pyrometallurgical processes to produce tin, or with respect to FIG. 9, the geothermally powered tin production system 410 use the heat transfer fluid 404c to drive refining processes to produce tin. For example, a motor of the geothermally powered hydrometallurgical tin production system may be powered by the heat transfer fluid 404c, and the motor may provide motion to a hopper, crusher, conveyor, fluid pump(s), and/or the like (see FIG. 5 and corresponding descriptions below). As another example, a geothermally powered hydrometallurgical tin production system may include a fluid pump with a motor that is powered at least in part by the heat transfer fluid (e.g., steam) heated in the wellbore 302. As another example, a geothermally powered hydrometallurgical tin production system may include a motor that aids in moving a screen in a sorter and is powered by heat transfer fluid (e.g., steam) heated in the wellbore 302.

In some cases, cooling may be desirable for certain processes. An absorption chiller may use heated fluid from the geothermal system to provide such cooling. In some cases, temperature adjustments or control may be achieved using heated fluid from the geothermal system and/or cooling from a geothermally powered absorption chiller. In this way, for example, smelting can be improved by operating at a temperature that facilitates more effective electrolytic reduction. More generally, reaction conditions can be adjusted to improve production of tin using hot or cold fluid obtained via geothermal energy with limited or no use of other energy inputs, and by using a temperature control system to maintain the temperature between a desired minimum and maximum values to improve product yield and to reduce the generation of unwanted byproducts. More detailed examples of operations of a geothermally powered hydrometallurgical tin production system and geothermally powered pyrometallurgical tin production system are provided below with respect to FIGS. 5 and 7.

Heat transfer fluid (e.g., condensed steam) that is cooled and/or decreased in pressure after powering the geothermally powered tin production system 410 may be returned to the wellbore 302 as heat transfer fluid 406a. For instance, as shown in the example of FIG. 4, a stream of return heat transfer fluid 406c may be provided back to the thermal process system 304, used to drive one or more reactions or processes, and then expelled as heat transfer fluid 406a for return to the wellbore 302. The heat transfer fluid 406a can also include a bypass stream of heat transfer fluid 406b, which can be formed from heat transfer fluid 406c, in whole or in part. Restated, thermally processed return stream of heat transfer fluid 406a includes heat transfer fluid (e.g., condensed steam) from the thermal process system 304 and/or the bypass stream of heat transfer fluid 406b. Thermally processed return stream of heat transfer fluid 406a that is sent back to the wellbore 302 may be water (or another heat transfer fluid), while the stream of heat transfer fluid 404a received from the wellbore 302 is steam (or another heat transfer fluid at an elevated temperature and/or pressure). While the example of FIG. 4 includes the thermal process system 304 of FIG. 3, in some cases, the combined geothermal and tin production system 400 may exclude all or a portion of the thermal process system 304. For example, the wellbore stream of heat transfer fluid 404a from the wellbore 302 may be provided directly to the geothermally powered tin production system 410 (see wellbore bypass stream of heat transfer fluid 404b described above).

Heat transfer fluid in streams 404a-c and 406a-c may be any appropriate fluid for absorbing heat within the wellbore 302 and driving operations of the geothermally powered tin production system 410 and, optionally the thermal process system 304. For example, the heat transfer fluid may include water, a brine solution, one or more refrigerants, a thermal oil (e.g., a natural or synthetic oil), a silicon-based fluid, a molten salt, a molten metal, or a nanofluid (e.g., a carrier fluid containing nanoparticles). A molten salt is a salt that is a liquid at the high operating temperatures experienced in the wellbore 302 (e.g., at temperatures between 1,600 and 2,300° F.). In some cases, an ionic liquid may be used as the heat transfer fluid. An ionic liquid is a salt that remains a liquid at more modest temperatures (e.g., at or near room temperature). In some cases, a nanofluid may be used as the heat transfer fluid. The nanofluid may be a molten salt or ionic liquid with nanoparticles, such as graphene nanoparticles, dispersed in the fluid. Nanoparticles have at least one dimension of 100 nanometers (nm) or less. The nanoparticles increase the thermal conductivity of the molten salt or ionic liquid carrier fluid. This disclosure recognizes that molten salts, ionic liquids, and nanofluids can provide improved performance as heat transfer fluids in the wellbore 302. For example, molten salts and/or ionic liquids may be stable at the high temperatures that can be reached in the wellbore 302. The high temperatures that can be achieved by these materials not only facilitate increased energy extraction but also can drive thermal processes that were previously inaccessible using previous geothermal technology. The heat transfer fluid may be selected at least in part to limit the extent of corrosion of surfaces of the combined geothermal and tin production system 400. As an example, the heat transfer fluid may be water. The water is supplied to the wellbore 302 as stream of heat transfer fluid 406a in the liquid phase and is transformed into steam within the wellbore 302. The steam is received as stream of heat transfer fluid 404a and used use to drive the geothermally powered tin production system 410.

### Example Geothermally Powered Hydrometallurgical Tin Production System

FIG. 5 shows an example of a geothermally powered hydrometallurgical tin production system 500 that can be used as part of the system 410 in FIG. 4. The configuration of FIG. 5 is provided as an example only. The geothermally powered hydrometallurgical tin production system 500 may include more or fewer components, and the components may be arranged in different configurations to produce tin concentrate 548. The example geothermally powered hydrometallurgical tin production system 500 includes a hopper 506, a crusher 508, a scrubber 510, a sorter 524, a dryer 530, and a separator 538. These main components and other components may be powered at least partially by geothermal energy from the heat transfer fluid 404c (e.g., steam). This heat transfer fluid 404c may be used directly to heat components in geothermally powered hydrometallurgical tin production system 500 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered hydrometallurgical tin production system 500. The geothermally powered hydrometallurgical tin production system 500 extracts tin-bearing materials from tin oxide ore 504a (i.e., tin-bearing oxide minerals) to produce a tin concentrate 548 that is used to produce tin using hydrometallurgical systems and methods.

During operation of the geothermally powered hydrometallurgical tin production system 500, a tin oxide ore 504a enters the hopper 506 and is crushed and ground by the crusher 508. Tin may be extracted from tin oxide ores, such as cassiterite (SnO₂), or rocks that bear trace amounts of tin oxides. The hopper 506 can be any appropriate type of open funnel that receives tin oxide ore 504a. It may contain a screen or a feeder. A geothermally powered motor 502 coupled to the crusher 508 may power the crusher 508. The geothermally powered motor 502 can be coupled to system components, such as the crusher 508, using conventional means, e.g., mechanical, electrical, pneumatic, etc., which are omitted for the sake of simplicity. The crusher 508 can be any appropriate type of machine that operates by rolling, impacting, milling, vibrating, and/or grinding. In the example of FIG. 5, the crusher 508 may be a jaw crusher, impact crusher, or ball mill. The geothermally powered motor 502 may be powered directly by the heat transfer fluid 404c that is heated by the magma reservoir 214 or using electricity 408. An example of geothermally powered motor is described in U.S. Provisional Patent Application No. 63/448,929, filed Feb. 28, 2023, and titled “Drilling Equipment Powered by Geothermal Energy,” the entirety of which is incorporated herein by reference.

The crushed tin oxide ore 504b is added to the scrubber 510 along with water 512 (or another wash liquid) to be washed to produce a wash mixture 514. The scrubber 510 is a vessel that can accommodate receiving and accumulating the crushed tin oxide ore 504b and can accommodate receiving water 512. The scrubber 510 can remove water soluble waste materials from the crushed tin oxide ore 504b by moving the material with the water 512. The scrubber 510 may be a rotary scrubber, a screw washer, a log washer, or a trommel screen, as examples. The scrubber 510 moves the crushed tin oxide ore 504b and the water 512 by tumbling, mixing, or rolling. The scrubber 510 may include screens, rollers, lifters, and drums. The scrubber 510 may use a screen 516 to separate a scrubber waste 518 from the wash mixture 514. Example screens are classifiers and hydrocyclones. The scrubber 510 removes the scrubber waste 518 and controls the size of particle that is permitted as a constituent of a washed tin oxide 522. The scrubber waste 518 may be clays, coatings, or deleterious materials. The scrubber waste 518 is transferred to a scrubber waste outlet 520 for further processing. The washed tin oxide 522 may be processed by the crusher 508 or the scrubber 510 one or more times before transferring for further processing.

The washed tin oxide 522 is received by the sorter 524 to be sorted into distinct size ranges of washed tin oxide 522. The sorter 524 is any device that can receive the washed tin oxide 522 and sort the washed tin oxide 522 by particle size. In the example of FIG. 5, the washed tin oxide 522 is sorted by a geothermally powered motor 502 that moves a shaker 526. The shaker 526 may include one or more of a jig, chute, shaking table, or shaking board, as examples. The shaker 526 physically separates the washed tin oxide 522 by moving the washed tin oxide 522 by shaking, vibrating, rocking, or the like to control the movement of particles according to their size and/or mass to produce a sorted tin oxide 528. In FIG. 5, the sorter 524 is depicted as producing the sorted tin oxide 528 to transfer to the dryer 530, but in other embodiments, the sorted tin oxide 528 may be processed by the sorter 524 more than once before it is transferred to the dryer 530. In other embodiments, the sorted tin oxide 528 may be transferred to the scrubber 510 to be washed more than once.

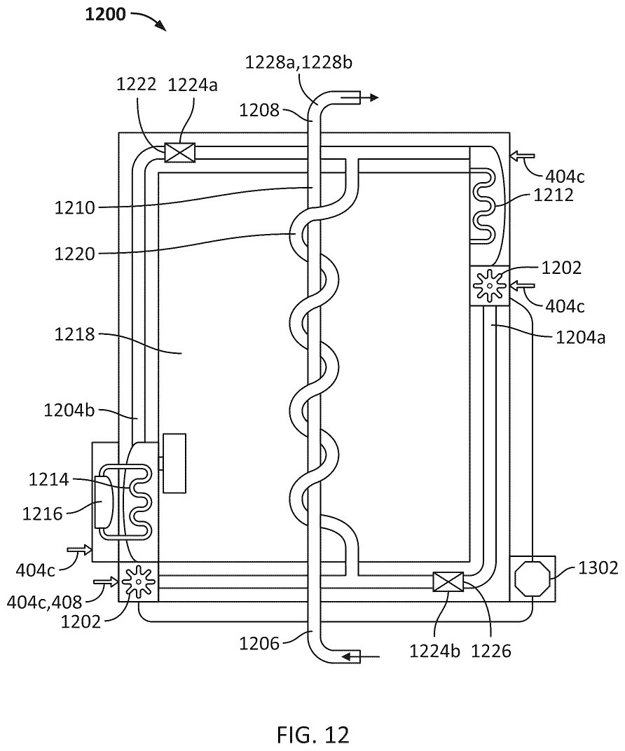

The sorted tin oxide 528 is received by the dryer 530 to be dried. In FIG. 5, the dryer 530 is depicted as positioned to dry the sorted tin oxide 528 after being produced by the sorter 524, but in other embodiments the dryer 530 may be arranged to process the washed tin oxide 522 to produce dried tin oxide 536 before being sorted to produce the sorted tin oxide 528. In other embodiments, tin oxide ore may be processed by the sorter 524 and the dryer 530 more than once. The dryer 530 is any vessel that can be heated and can receive and handle the sorted tin oxide 528. The dryer 530 can use heat to remove water from the sorted tin oxide 528 to produce the dried tin oxide 536. The dryer 530 may be a mesh belt dryer or a rotary dryer, as examples. The temperature of the dryer 530 is maintained at an elevated temperature (e.g., 50 to 140° C.). Heat can be provided by a heat exchanger 534, which can be heated by heat transfer fluid 404c. The heat exchanger 534 is depicted as disposed within the dryer 530 in FIG. 5 to provide heat directly to the sorted tin oxide 528, but in other embodiments the heat exchanger 534 can be arranged to heat the walls of the dryer 530 which can then heat the sorted tin oxide 528. Examples of the heat exchanger 534 include shell-and-tube or tube-in-tube type heat exchangers. Temperature may be controlled using a temperature control system (see FIG. 12) positioned within or proximate to the dryer 530. A dryer conveyor 532 conveys the sorted tin oxide 528 through the dryer 530 during the drying process across the length of the vessel. The dryer conveyor 532 may be driven by a geothermally powered motor 502. The dryer conveyor 532 can convey the sorted tin oxide 528 by a rolling motion, sliding motion, or radial motion, for example, along a belt or roller system, or moved in a fluidized bed.

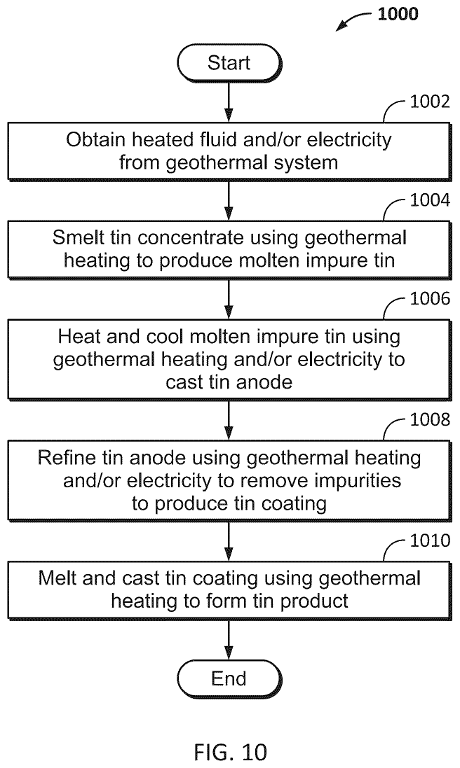

The dried tin oxide 536 is received by a separator 538 to be purified to remove tailings 544 (i.e., material with low tin content) to produce a tin concentrate 548 (i.e., material with high tin content). The separator 538 is any vessel that can receive and handle the dried tin oxide 536 to produce a tin concentrate 548. In the example of FIG. 5, the separator 538 uses a magnet 542 to remove tailings 544 by magnetic separation. The magnet 542 can use an electrical current to power a magnetic field to produce differential movement of mineral particles through the magnetic field. The different magnetic susceptibility of minerals is used as the basis of separation to purify the tin concentrate 548. In the example of FIG. 5, ferromagnetic materials (i.e., materials strongly attracted to a magnetic field) are removed as tailings 544. An example ferromagnetic material is magnetite (Fe²⁺Fe³⁺₂O₄). The electrical current used to power the magnet 542 may be supplied by electricity 408 derived from the conversion of heat in the heat transfer fluid 404c by turbines (e.g., turbines 1104, 1108 of FIG. 11). The magnet 542 may be a rotating drum, vertical spout, suspended belt, head pulley, plate, hump, tube-and-grate, drawer, or angled spout, as examples. A separator conveyor 540 conveys the dried tin oxide 536 through the separator 538 during the separation process across the length of the vessel. The separator conveyor 540 may be driven by a geothermally powered motor 502. The separator conveyor 540 can convey the dried tin oxide 536 by a rolling motion, sliding motion, or radial motion, for example, along a belt or roller system, or moved in a fluidized bed. The tailings 544 are removed from the dried tin oxide 536 by using conventional means, e.g., mechanical, electrical, pneumatic, etc., which are omitted for the sake of simplicity. The purification of the dried tin oxide 536 produces the tin concentrate 548. The tin concentrate 548 is the product. The tin concentrate 548 contains an enriched amount of tin (e.g., 70 to 75%) after processing from its state as the tin oxide ore 504a (e.g., potentially <1%) and is prepared for further processing by refining (see FIGS. 9 and 10).

### Example Method of Geothermally Powered Hydrometallurgical Tin Production

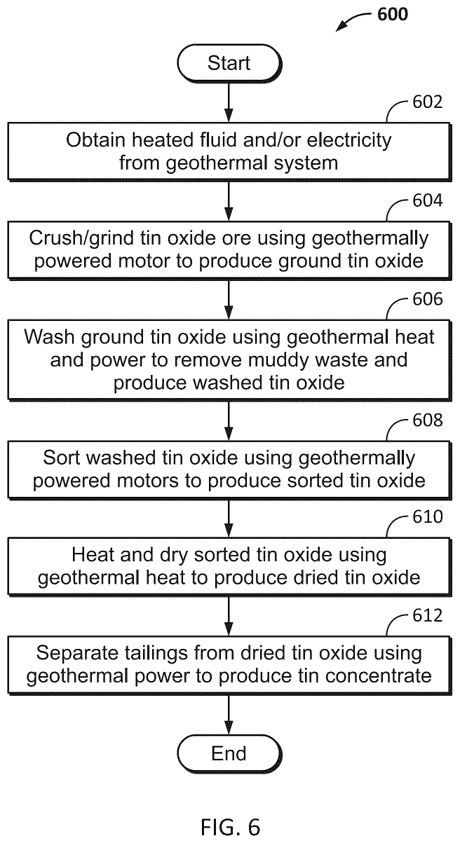

FIG. 6 shows an example method 600 of operating the geothermally powered hydrometallurgical tin production system 500 in FIG. 5. The method 600 may begin at step 602. At step 602, the heated heat transfer fluid 404c and/or electricity 408 are received from the geothermal system, as described above with respect to FIGS. 1-4. At step 604, tin oxide ore 504a is crushed and/or ground (e.g., using a geothermally powered motor 502) to produce a ground tin oxide ore 504b. At step 606, the ground tin oxide ore 504b is washed (e.g., using a geothermally powered motor 502 to move a screen 516 to cause water 512 and the ground tin oxide ore 504b to also move), such that muddy waste is removed to produce washed tin oxide 522.

At step 608, the washed tin oxide 522 is sorted by using a geothermally powered motor 502 to direct the washed tin oxide 522 by grain size and/or mass to distinct bins to produce a sorted tin oxide 528. At step 610, the sorted tin oxide 528 is heated and dried using the heat transfer fluid 404c to produce dried tin oxide 536. At step 612, tailings 544 (i.e., ferromagnetic waste material) are removed from the dried tin oxide 536 by a magnet 542 to produce a purified tin concentrate 548. Step 612 may be driven by current being generated by electricity 408 from the geothermally powered turbines 1104, 1108 configured to use the heat transfer fluid 404c heated by the geothermal system.

Modifications, omissions, or additions may be made to method 600 depicted in FIG. 6. Method 600 may include more, fewer, or other steps. For example, at least certain steps may be performed in parallel or in any suitable order. While at times discussed as geothermally powered hydrometallurgical tin production system 500 performing steps, any suitable component of the geothermally powered hydrometallurgical tin production system 500 or other components of a geothermal system may perform or may be used to perform one or more steps of the method 600.

### Example Geothermally Powered Pyrometallurgical Tin Production System

FIG. 7 shows an example of a geothermally powered pyrometallurgical tin production system 700 that can be used as the system 410 of FIG. 4. The configuration of FIG. 7 is provided as an example only. The geothermally powered pyrometallurgical tin production system 700 may include more or fewer components, and the components may be arranged in different configurations in order to produce tin concentrate 786. The example geothermally powered pyrometallurgical tin production system 700 includes a hopper 706, a crusher 708, a scrubber 710, a sorter 724, a flotation tank 730, a separator 750, a dryer 762, a roaster 768, and a leach tank 774. These main components and other components may be powered at least partially by geothermal energy from the heat transfer fluid 404c (e.g., steam). Heat transfer fluid 404c may be used directly to heat components in the geothermally powered pyrometallurgical tin production system 700 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered pyrometallurgical tin production system 700. The geothermally powered pyrometallurgical tin production system 700 extracts tin-bearing materials from tin sulfide ore 704a (i.e., tin-bearing sulfide minerals) to produce a tin-rich froth 746 that is used to produce tin concentrate 782 using pyrometallurgical systems and methods.

During operation of the geothermally powered pyrometallurgical tin production system 700, a tin sulfide ore 704a enters a hopper 706 and is crushed and ground by the crusher 708. Tin may be extracted from any number of tin sulfide ores, such as stannite (Cu₂FeSnS₄), cylindrite (Pb₃Sn₄FeSb₂S₁₄), franckeite (Pb₅Sn₃Sb₂S₁₄), canfieldite (Ag₈SnS₆), and teallite (PbSnS₂). The hopper 706 can be any appropriate type of vessel (e.g., an open funnel) that receives tin sulfide ore 704a. It may contain a screen or a feeder. A geothermally powered motor 702 may be coupled to the crusher 708 to power the crusher 708. The geothermally powered motor 702 can be coupled to system components, such as the crusher 708, using conventional means, e.g., mechanical, electrical, pneumatic, etc., which are omitted for the sake of simplicity. The crusher 708 can be any appropriate type of machine that operates by rolling, impacting, milling, vibrating, and/or grinding. For example, the crusher 708 may be a jaw crusher, impact crusher, or ball mill. The geothermally powered motor 702 may be geothermally powered directly by the heat transfer fluid 404c that is heated by the magma reservoir 214. An example of geothermally powered motor 702 is described above with respect to motor 502 of FIG. 5.

Ground tin sulfide 704b enters the scrubber 710 along with water 712 (or another washing liquid) to be washed to produce a wash mixture 714. The scrubber 710 is a vessel that can accommodate receiving and accumulating the ground tin sulfide ore 704b and can accommodate receiving water 712. The scrubber 710 can remove water soluble waste materials from the ground tin sulfide ore 504b by moving the material with the water 712. The scrubber 710 may be a rotary scrubber, a screw washer, a log washer, or a trommel screen, as examples. The scrubber 710 moves the ground tin sulfide ore 704b and the water 712 by tumbling, mixing, or rolling. The scrubber 710 may include screens, rollers, lifters, and drums. The scrubber 710 may use a screen 716 to separate a scrubber waste 718 from the wash mixture 714. Example screens are classifiers and hydrocyclones. The scrubber 710 removes the scrubber waste 718 and controls the size of particle that is permitted as a constituent of a washed tin sulfide 722. The scrubber waste 718 may be clays, coatings, or deleterious materials. The scrubber waste 718 is transferred to a scrubber waste outlet 720 for further processing. The washed tin sulfide 722 may be processed by the crusher 708 or the scrubber 710 one or more times before transferring for further processing.

The washed tin sulfide 722 is received by a sorter 724 to be sorted into distinct size ranges of washed tin sulfide 722. The sorter 724 is any device that can receive the washed tin sulfide 722 and is capable of sorting the washed tin sulfide 722 by particle size. In the example of FIG. 5, the washed tin sulfide 722 is sorted by a geothermally powered motor 702 that moves a shaker 726. The shaker 726 may include one or more of a jig, chute, shaking table, or shaking board, as examples. The shaker 726 physically separates the washed tin sulfide 722 by moving the washed tin sulfide 722 by shaking, vibrating, rocking, or the like to control the movement of particles according to their size and/or mass to produce a sorted tin sulfide 728. In FIG. 7, the sorter 724 is depicted as producing the sorted tin sulfide 728 to transfer to a flotation tank 730, but in other embodiments, the sorted tin sulfide 728 may be processed by the sorter 724 more than once before it is transferred to the flotation tank 730. In other embodiments, the sorted tin sulfide 728 may be transferred to the scrubber 710 to be washed more than once.

The sorted tin sulfide 728 is received by a flotation tank 730 to be processed into a slurry 734. The flotation tank 730 is any vessel that can accommodate input of reagents and can be maintained at a desired temperature to facilitate the extraction of tin materials from the ground tin sulfide 704b. In the flotation tank 730, the ground tin sulfide 704b is combined with flotation reagents 732 and water. The flotation reagents 732 are any chemical(s) or other material(s) capable of selectively separating hydrophobic materials from hydrophilic materials in the slurry 734 based, for example, on the differences in wettabilities of different materials. Examples of flotation reagents 732 include frothers (which permit and stabilize bubble formation), promoters or collectors (which decrease the wettability of the desired mineral), modifiers (which increase wettability of the undesired mineral), depressors (which render floatable minerals unfloatable), and activators (which render unfloatable minerals, previously rendered so by depressors, floatable). Flocculants or coagulants may also be used to cause desired or undesired minerals to clump.

Example collectors for sulfide minerals are xanthates. Xanthates may be used for tin sulfides, due to their high selectivity for sulfide minerals. Xanthates chemically react with sulfides and do not react appreciably with non-sulfide byproducts 742. In the example of FIG. 7, sodium ethyl xanthate (CH₃CH₂OCS₂Na) may be one of the flotation reagents 732. The OCSS⁻ group of sodium ethyl xanthate irreversibly attaches to the sulfide mineral surface, rendering the sulfide hydrophobic. Additional flotation reagents 732 may be added to the slurry 734 to adjust for varying mineral constituents present in the ground tin sulfide 704b (e.g., iron, lead, copper), and may be added simultaneously or step-wise. Additional flotation tanks 710 may be used to float different target metals (e.g., iron, lead, copper) and remove different byproducts using different flotation reagents 732. For example, a flotation tank 710 may be used to float iron prior to floating copper, in which appropriate flotation reagents 732 are used to target iron. Such a flotation tank 710 may be used before or after or simultaneously to one or more additional flotation tanks to extract tin and other metals that may be present in the ore. Tin oxide ores may be processed in a similar system using flotation reagents appropriate for targeting oxides (e.g., sodium salt of crude or refined petroleum sulfonic acids).

The flotation tank 710 may be maintained at an elevated temperature appropriate for the mineral content of the ground tin sulfide 704b (e.g., about 45° C.) and a pH in a target range (e.g., in a range from about 5 to 11.5). The elevated temperature of the flotation tank 710 can be provided by a heat exchanger 736a, which can be heated by the heat transfer fluid 404c. The heat exchanger 736a is depicted as disposed within the flotation tank 710 in FIG. 7 to provide heat directly to the slurry 734, but in other embodiments the heat exchanger 736a can be arranged to heat the walls of the flotation tank 710 which can then heat the slurry 734. Temperature may be controlled using a temperature control system (see FIG. 12) positioned within or proximate to the flotation tank 710. Heat exchange between the heat exchanger 736a and the slurry 734 and/or flotation tank 710 induces a reaction to form a froth 746 containing tin particles 748. Examples of the heat exchanger 736a include shell-and-tube or tube-in-tube type heat exchangers. A mixer 738 and an air intake 740 may be used to enhance agitation of the slurry 734. The mixer 738 is any machine capable of agitating the slurry 734 contained by the flotation tank 710. In the example of FIG. 7, a geothermally powered motor 702 rotates the mixer 738. The mixer 738 may be beaters, paddles, propellers, hydrofoils, or turbines, as examples. The air intake 740 is any machine capable of introducing air into the slurry 734 contained by the flotation tank 710. In the example of FIG. 7, a geothermally powered motor 702 powers the air intake 740. The air intake 740 may be aerators, bubblers, or spargers, as examples. During flotation in the flotation tank 710, byproducts 742 (e.g., iron) may be removed from the slurry 734 where at least a portion may be transferred to a waste collection reservoir 744.

The froth 746 containing tin particles 748 is received by the separator 750 to be purified to remove tailings 756 (i.e., material with low tin content) to produce a separated tin sulfide 760 (i.e., material with high tin content). The separator 750 is any vessel that can receive and handle the froth 746 containing tin particles 748 to produce a separated tin sulfide 760. In the example of FIG. 7, the separator 750 uses a magnet 754 to remove the tailings 756 by magnetic separation. The magnet 754 can use an electrical current to generate a magnetic field to produce differential movement of mineral particles through the magnetic field. In the example of FIG. 5, ferromagnetic materials (i.e., materials strongly attracted to a magnetic field) are removed as tailings 756. An example ferromagnetic material is magnetite (Fe²⁺Fe³⁺₂O₄). The electrical current used to power the magnet 754 may be supplied by electricity 408 derived from the conversion of heat in the heat transfer fluid 404c by turbines (e.g., turbines 1104, 1108 of FIG. 11). The magnet 754 may be a rotating drum, vertical spout, suspended belt, head pulley, plate, hump, tube-and-grate, drawer, or angled spout, as examples. A separator conveyor 752 conveys the tin particles 748 through the separator 750 during the separation process across the length of the vessel and is driven by a geothermally powered motor 702. The separator conveyor 752 can convey the tin particles 748 by a rolling motion, sliding motion, or radial motion, for example, along a belt or roller system, or moved in a fluidized bed. The tailings 756 are removed from the tin particles 748 by using conventional means, e.g., mechanical, electrical, pneumatic, etc., which are omitted for the sake of simplicity. The purification of the tin particles 748 produces the separated tin sulfide 760. The separated tin sulfide 760 is the product.

The separated tin sulfide 760 is received by the dryer 762 to be dried to remove water (i.e., dewatering) used by the scrubber 710. In FIG. 7, the dryer 762 is depicted as positioned to dry the separated tin sulfide 760 after being produced by the separator 750 processing the tin particles 748, but in other embodiments the dryer 762 can be arranged to process the tin particles 748 to produce dried tin particles before being separated to produce the separated tin sulfide 760. In other embodiments, tin particles 748 may be processed by the separator 750 and the dryer 762 more than once. The dryer 762 is any vessel that can be heated and can receive and handle the separated tin sulfide 760. The dryer 762 can use heat to remove water from the separated tin sulfide 760 to produce the dried tin sulfide 766. The dryer 762 may be a mesh belt dryer or a rotary dryer, as examples. The temperature of the dryer 762 is maintained at an elevated temperature (e.g., 50 to 140° C.). Heat can be provided by a heat exchanger 736b, which can be heated by heat transfer fluid 404c. The heat exchanger 736b is depicted as disposed within the dryer 762 in FIG. 7 to provide heat directly to the separated tin sulfide 760, but in other embodiments the heat exchanger 736b can be arranged to heat the walls of the dryer 762 which can then heat the separated tin sulfide 760. Examples of the heat exchanger 736b include shell-and-tube or tube-in-tube type heat exchangers. Temperature may be controlled using a temperature control system (see FIG. 12) positioned within or proximate to the dryer 762. A dryer conveyor 764 conveys the separated tin sulfide 760 through the dryer 762 during the drying process across the length of the vessel and is driven by a geothermally powered motor 702. The dryer conveyor 764 can convey the separated tin sulfide 760 by a rolling motion, sliding motion, or radial motion, for example, along a belt or roller system, or moved in a fluidized bed. The dried tin sulfide 766 is the product.

The dried tin sulfide 766 is then heated in the roaster 768 to remove sulfur to produce tin oxide 772. The roaster 768 is any vessel that can be heated and can receive and handle the dried tin sulfide 766. The roaster 768 can be heated by a heat exchanger 736c, which can be heated by the heat transfer fluid 404c. The heat exchanger 736c is depicted as disposed within the roaster 768 in FIG. 7 to provide heat directly to the dried tin sulfide 766, but in other embodiments the heat exchanger 736c can be arranged to heat the walls of the roaster 768 which can then heat the dried tin sulfide 766. Examples of the heat exchanger 736c include shell-and-tube or tube-in-tube type heat exchangers. Temperature may be controlled using a temperature control system (see FIG. 12) positioned within or proximate to the roaster 768. A roaster conveyor 770 conveys the dried tin sulfide 766 through the roaster 768 during the roasting process across the length of the chamber and is driven by a geothermally powered motor 702. The roaster conveyor 770 can convey the dried tin sulfide 766 by a rolling motion, sliding motion, or radial motion, for example, along a belt or roller system, or moved in a fluidized bed. The roaster 768 can be a reverberating furnace, multiple-hearth roaster, a suspension roaster, or a fluidized-bed roaster, and heats the dried tin sulfide 766 to elevated temperature (e.g., 550 to 650° C.). Roasting drives off sulfur to produce the tin oxide 772. Depending on the type and quantity of impurities, oxidizing, reducing, or chlorinating reactions take place. An example set of oxidation reactions is 2SnS+3O₂→2SnO+2SO₂ and 2SnO+O₂→2SnO₂. The tin oxide 772 is a product of this process.

The tin oxide 772 is received by the leach tank 774 where it may be further processed by leaching. The leach tank 774 is any vessel that can extract Sn²⁺ (from SnO) and Sn⁴⁺ (from SnO₂) into a leach product 780 (a tin-containing solution) and separate it from leach residue 788 (insoluble byproducts). The leach product 780 is agitated by a mixer 782. The mixer 782 is any machine capable of agitating the leach product 780 contained by the leach tank 774. In the example of FIG. 7, a geothermally powered motor 702 rotates the mixer 782. The mixer 782 may be beaters, paddles, propellers, hydrofoils, or turbines, as examples. The temperature of the leach tank 774 is maintained at a slightly elevated temperature (e.g., 80° C.). Heat can be provided by a heat exchanger 736d, which can be heated by the heat transfer fluid 404c. The heat exchanger 736d is depicted as disposed within the leach tank 774 in FIG. 7 to provide heat directly to the leach product 780, but in other embodiments the heat exchanger 736d can be arranged to heat the walls of the leach tank 774 which can then heat the leach product 780. Examples of the heat exchanger 736d include shell-and-tube or tube-in-tube type heat exchangers. Temperature may be controlled using a temperature control system (see FIG. 12) positioned within or proximate to the leach tank 774. A leach reagent 776 is used to perform the extraction of tin. Tin extraction may occur at acidic or basic conditions due to its amphoteric nature. Dilute nitric acid is an example reagent. The leach reagent 776 causes reactions to break down the tin oxide 772 to liberate tin and to remove some impurities (e.g., iron oxide) that were made soluble by roasting but not removed during mineral processing or roasting. An example set of reactions is SnO+H₂SO₄→Sn²⁺SO₄+H₂O and SnO₂+H₂SO₄→Sn⁴⁺+SO₄+H₂O to produce tin-rich leach product 780. Leach residue 788 settles to the bottom of the leach tank 774 where it may be collected in a leach residue reservoir 790. The leach product 780 can be filtered by a filter 784 to separate the tin-rich solid material from the liquid material to produce tin concentrate 786. The filter 784 is any machine capable of removing at least one component from the leach product 780. Filtration may be performed by chemical and/or mechanical means. In the example of FIG. 7, the filter 784 is driven by a geothermally powered motor 702. The filter 784 can be a drum filter or vacuum filter, as examples. The tin concentrate 786 is the product. The tin concentrate 786 contains an enriched amount of tin (e.g., 50 to 60%) after processing from its state as the tin sulfide ore 704a (e.g., may be <1%) and is prepared for further processing by refining.

### Example Method of Geothermally Powered Pyrometallurgical Tin Production

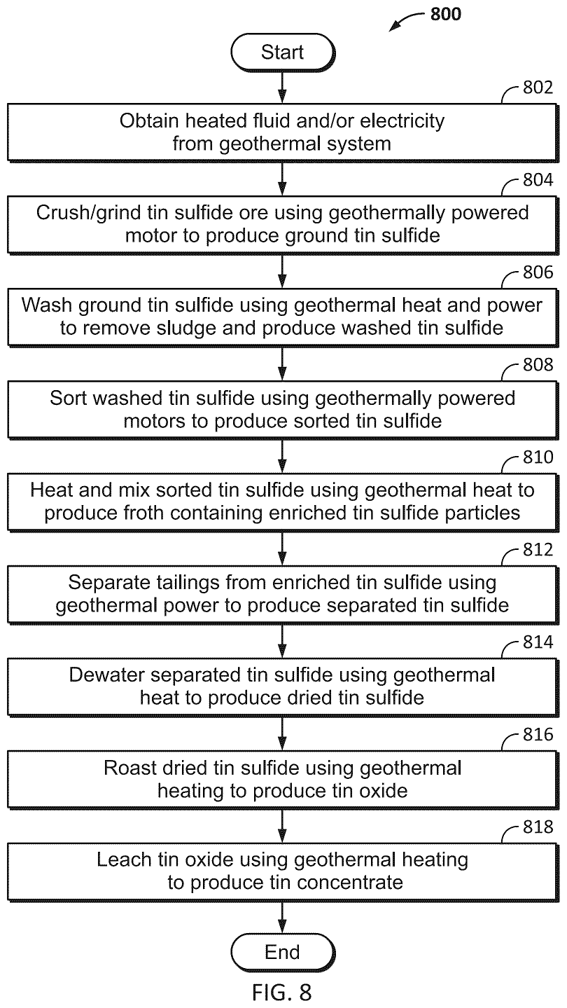

FIG. 8 shows an example method 800 of operating the geothermally powered pyrometallurgical tin production system 700 in FIG. 7. The method 800 may begin at 802. At step 802, the heated heat transfer fluid and/or electricity 408 are received from the geothermal system, as described above with respect to FIGS. 1-4. At step 804, tin sulfide ore 704a is crushed and/or ground using a geothermally powered motor 702 to produce a ground tin sulfide 704b. At step 806, the ground tin sulfide 704b is washed using a geothermally powered motor 702 to move a screen 716 to cause water 712 and the ground tin sulfide 704b to move to remove muddy waste to produce washed tin sulfide 722. At step 808, the washed tin sulfide 722 is sorted by using a geothermally powered motor 702 to direct the washed tin sulfide 722 by grain size and/or mass to distinct bins to produce a sorted tin sulfide 728. At step 810, the sorted tin sulfide 728 a slurry 734 is produced by combining and mixing the sorted tin sulfide 728 with flotation reagents 732 and air from an air intake 740 and heating with the heat transfer fluid 404c to produce a froth 746 containing tin particles 748 in the slurry 734. At step 812, tailings 756 (i.e., ferromagnetic waste material) are removed from the tin particles 748 contained by the froth 746 by a magnet 754 to produce a separated tin sulfide 760. Step 812 may be driven by current being generated by electricity 408 from the geothermally powered turbines 1104, 1108 configured to use the heat transfer fluid 404c heated by the geothermal system. At step 814, the separated tin sulfide 760 is heated and dried using the heat transfer fluid 404c to produce dried tin sulfide 766. At step 816, the dried tin sulfide 766 is roasted with the heat transfer fluid 404c to produce tin oxide 772. At step 818, the tin oxide 772 is oxide is leached by combining and mixing with leach reagents 776 and heating with the heat transfer fluid 404c to produce a leach product 780. The leach product 780 is processed by using a filter 784 powered by using the heat transfer fluid 404c to produce a tin concentrate 786.

Modifications, omissions, or additions may be made to method 800 depicted in FIG. 8. Method 800 may include more, fewer, or other steps. For example, at least certain steps may be performed in parallel or in any suitable order. While at times discussed as geothermally powered pyrometallurgical tin production system 700 performing steps, any suitable component of the geothermally powered pyrometallurgical tin production system 700 or other components of a geothermal system may perform or may be used to perform one or more steps of the method 800.

### Example Geothermally Powered Tin Refining System

The tin concentrate 548 produced by the geothermally powered hydrometallurgical tin production system 500 and the tin concentrate 786 produced by the geothermally powered pyrometallurgical tin production system 700 may be processed by a geothermally powered tin refining system to produce tin product 942. FIG. 9 shows an example of the geothermally powered tin refining system 900. The configuration of FIG. 9 is provided as an example only. The geothermally powered tin refining system 900 may include more or fewer components, and the components may be arranged in different configurations to produce tin product 942. The example geothermally powered tin refining system 900 includes a smelting furnace 904, an anode smelter 930, an electrolytic smelter 934, and a foundry 942. These main components and other components may be powered at least partially by geothermal energy from the heat transfer fluid 404c (e.g. steam), which obtained its heat from the magma reservoir 214 via the stream of heat transfer fluid 404a. This heat transfer fluid 404c may be used directly to heat components in the geothermally powered tin refining system 900 or to heat a secondary heat transfer fluid. The secondary heat transfer fluid may be any similarly suitable fluid as chosen in the primary heat transfer fluid 404c. The heat transfer fluid 404c or secondary heat transfer fluid may be used to heat components or may be converted to mechanical or electrical energy to perform operations in the geothermally powered tin refining system 900.

The tin concentrate 548 and tin concentrate 786 are received by the smelting furnace 904 where they may be further processed by smelting with heat and smelting reagents 906. The smelting furnace 904 is any vessel that can be heated and can receive and process the tin concentrate 548 and tin concentrate 786. The smelting furnace 904 can be a reverberatory furnace, blast furnace, or electric furnaces, as examples. In the example FIG. 9, a blast furnace is shown. The tin concentrate 548 and tin concentrate 786 contains up to 75% tin. Smelting in the smelting furnace further increases purity of the tin concentrate 548 and tin concentrate 786 to up to 95% tin in 30 to 40 minutes for a 300 kg charge of starting material. The temperature of the smelting furnace 904 is maintained at an elevated temperature (e.g., 1300 to 1400° C.). Heat can be provided at least in part by an air intake heat exchanger 914a, which injects heated compressed air 910b into the smelting furnace 904 by using an air compressor 912 powered by geothermally generated electricity 408. The heated compressed air 910b can be produced by heating air 910a by using the air intake heat exchanger 914a which can be heated by heat transfer fluid 404c. In FIG. 9, the air intake heat exchanger 914a is depicted as being arranged to heat the air 910a as it is directed from the air compressor 912 to the smelting furnace 904. Heated compressed air 910b then heats the inside of the smelting furnace 904 which can then heat the tin concentrate 548 and tin concentrate 786. In other embodiments the air intake heat exchanger 914a can be disposed within the smelting furnace 904. Additionally, in FIG. 9 a furnace heat exchanger 914b is depicted as being arranged to heat the walls of the smelting furnace 904 which can then heat the tin concentrate 548 and tin concentrate 786, but in other embodiments the furnace heat exchanger 914b can be disposed within the smelting furnace 904. Examples of the air intake heat exchanger 914a and the furnace heat exchanger 914b include shell-and-tube or tube-in-tube type heat exchangers.

Smelting melts the tin concentrate 548 and tin concentrate 786 into a molten impure tin 922 which then settles to the bottom of the smelting furnace 904 or is poured into a slag-settling furnace. The tin concentrate 548 and tin concentrate 786 contain tin sulfides, tin oxides, and some impurities including iron oxides. As the tin concentrate 548 and tin concentrate 786 are added to the smelting furnace 904, they are heated and accumulate to form buildup layers 916. The principle of tin smelting is the chemical reduction of tin oxide by heating with carbon to produce tin metal and carbon dioxide gas and are reacted with oxygen (present in the injected air) to generate tin oxides. In practice, the furnace feed contains the tin concentrate 548 and tin concentrate 786, which accumulate as buildup layers 916, and smelting reagents 906 (e.g., carbon in the form of anthracite coal or coke, limestone and silica to act as a flux and a slag-producing agent). The smelting furnace 904 is heated (e.g., 1300-1400° C.) for a period of time (e.g., 15 hours). A pool of molten impure tin 922 is produced, on top of which floats the molten slag 918 containing impurities. At the completion of smelting, the molten impure tin 922 is tapped off to be further refined if needed, while the molten slag 918 is transferred out where it may be recycled or further processed.

During smelting by the smelting furnace 904, heat supplied by the heated heat transfer fluid 404c and the smelting reagents 906 cause reactions to remove impurities from the molten impure tin 922. An example set of reactions is C+O₂→CO₂ and C+CO₂→2CO to produce reducing conditions, SnO₂+2CO→Sn+2CO₂ to reduce the molten impure tin 922 to produce tin and carbon dioxide, SiO₂+SnO→SnSiO₃ to react silica flux with tin oxide to produce stannous silicate, C+SnSiO₃→Sn+CO₂+SiO₂ and CaCO₃→CaO+CO₂ and CaO+SiO₂→CaSiO₃ to produce molten impure tin 922, capture carbon dioxide and remove silica from the molten impure tin 922 to produce a molten slag 918. The molten impure tin 922 settles as a molten layer at the bottom of the smelting furnace 904 where it can be transferred through a tin tap 924 to be further processed by the anode smelter 930. The molten impure tin 922 is the product. A layer of molten slag 918, a dense glassy material made of iron, silica, and other impurities, also settles at the bottom of the smelting furnace 904. The two molten layers are separate due to density differences. The molten slag 918 is transferred through a slag tap 920 to be further processed. The molten slag 918 may contain recoverable metals (e.g., indium, bismuth, and copper) which further processing can extract. A portion of volatile pollutants such as sulfur are oxidized and carried away as exhaust output 926 driven out by an exhaust system 928 powered by electricity 408 generated by heat in the geothermal system.

The molten impure tin 922 is transferred to an anode smelter 930 to burn off oxygen, pour into molds, and allowed to cool to produce a tin anode 932. The tin anode 932 is up to 99% tin and is the product.

Refining is performed to obtain a purified tin coating 940 from the tin anode 932. Two example methods of electrolytic refining are fire refining and electrolytic refining. In FIG. 9, electrolytic refining is shown. In other embodiments, fire refining (e.g., boiling, liquation, or vacuum distillation) may be used in addition to or in place of electrolytic refining. The tin anode 932 is installed in an electrolytic smelter 934 submerged in a smelting bath 936. The smelting bath 936 may be an acid or alkaline bath. Example acid baths are stannous sulfate, creosulfonic or phenolsulfonic acids, and free sulfuric acid. Beta naphthol and glue may be added to prevent deposits from forming on the cathode 938. Example alkaline baths are potassium or sodium stannite and free alkali. Electrolytic reduction is driven by a current between the cathode 938 which lines the smelting bath 936 and the tin anode 932. Example materials that may be used for the cathode 938 are thin sheets of tin installed between the anodes.

The electric current passes through the smelting bath 936, from the cathode 938 to the anode 932, causing tin to be plated on the cathode 938 as tin coating 940. The tin coating 940 is up to 99.99% pure and is removed from the cathode 938 periodically via conventional means and are omitted for the sake of simplicity. Electrolysis causes the tin coating 940 to deposit on the cathode 938 by the reaction Sn²⁺2e⁻→Sn(s) and tin to enter solution from the tin anode 932 by a reaction Sn(s)→Sn²⁺2e⁻. Electrolytic reduction may be maintained at an optimal temperature range (e.g., 20 to 40° C.) to improve tin collection efficiency. For example, the electrolytic smelter 934 may be heated or cooled accordingly, as needed, to maintain the temperature in the electrolytic smelter 934 at a target temperature or within a target temperature range. Temperature may be controlled using a temperature control system (see FIG. 12) positioned within or proximate to the electrolytic smelter 934.

Electrolysis requires a high energy demand. This disclosure provides a solution to this problem by facilitating the operation of the electrolytic smelter 934 using geothermal energy. For example, the current used for electrolysis may be supplied by electricity 408 derived from the conversion of heat in the heat transfer fluid 404c by turbines (e.g., turbines 1104, 1108 of FIG. 11). The smelting bath 936 is heated up to 1000° C. by a heat transfer fluid 404c to help improve electrolytic efficiency. This heating using heat from a geothermal well reduces cost and inefficiencies associated with conventional energy strategies such as fossil fuels.

The tin coating 940 may be received by the foundry 942 to produce tin product 946. The foundry 942 can be any vessel capable of receiving and the tin coating 940 and the heated heat transfer fluid 404c. The foundry 942 can be heated or cooled accordingly, as needed, to maintain the temperature in the foundry 942 at a target temperature or within a target temperature range. Temperature may be controlled using a temperature control system (see FIG. 10) positioned within or proximate to the foundry 942. The foundry 942 can heat the tin coating 940 to its melting point (i.e., 232° C.) to produce a molten tin 944. The molten tin 944 can be formed into masses of various shapes and sizes and cooled to produce the tin product 946. The tin product 946 may be cast into any desired shape, for example, ingots, wires, and tubing.

### Example Method of Geothermally Powered Tin Refining

FIG. 10 shows an example method 1000 of operating the geothermally powered tin refining system 900 in FIG. 9. The method 1000 may begin at 1002 where the heated heat transfer fluid 404c and/or electricity 408 are received from the geothermal system, as described above with respect to FIGS. 1-4. At step 1004, tin concentrate 548 and/or tin concentrate 786 are smelted in a smelting furnace 904 by combining and mixing with smelting reagents 906 and heated air 910b from a heated air system 908 heated with the heat transfer fluid 404c to produce a molten impure tin 922. At step 1006, the impure tin 922 is melted and cast into a tin anode 932 in the anode smelter 930. At step 1008, an electrolytic smelter 934 refines the tin anode 932 causing a tin coating 940 to deposit onto a cathode 938. Step 1008 may be driven by current between the tin anode 932 and the cathode 938 described in FIG. 9, the current being generated by electricity 408 from the geothermally powered turbines (see, e.g., turbines 1104, 1108 of FIG. 11) configured to use the heat transfer fluid 404c heated by the geothermal system. At step 1010, the tin coating 940 is heated by the heat transfer fluid 404c and cast in a foundry 942 to produce tin product 946.

Modifications, omissions, or additions may be made to method 1000 depicted in FIG. 10. Method 1000 may include more, fewer, or other steps. For example, at least certain steps may be performed in parallel or in any suitable order. While at times discussed as geothermally powered tin refining system 900 performing steps, any suitable component of the geothermally powered tin refining system 900 or other components of a geothermal system may perform or may be used to perform one or more steps of the method 1000.

### Example Thermal Process System

FIG. 11 shows a schematic diagram of an example thermal process system 304 of FIGS. 3 and 4. The thermal process system 304 includes a steam separator 1102, a first turbine set 1104, a second turbine set 1108, a high-temperature/pressure thermochemical process 1112, a medium-temperature/pressure thermochemical process 1114, and one or more lower temperature/pressure processes 1116a,b. The thermal process system 304 may include more or fewer components than are shown in the example of FIG. 11. For example, a thermal process system 304 used for power generation alone may omit the high-temperature/pressure thermochemical process 1112, medium-temperature/pressure thermochemical process 1114, and lower temperature/pressure processes 1116a,b. Similarly, a thermal process system 304 that is not used for power generation may omit the turbine sets 1104, 1108. As a further example, if heat transfer fluid is known to be received only in the gas phase, the steam separator 1102 may be omitted in some cases. The ability to tune the properties of the heat transfer fluid received from the unique wellbore 302 of FIGS. 3 and 4 facilitates improved and more flexible operation of the thermal process system 304. For example, the depth of the wellbore 302, the residence time of heat transfer fluid in the magma reservoir 214, the pressure achieved in the wellbore 302, and the like can be selected or adjusted to provide desired heat transfer fluid properties at the thermal process system 304.

In the example of FIG. 11, the steam separator 1102 is connected to the wellbore 302 that extends between a surface and the underground magma reservoir. The steam separator 1102 separates a vapor-phase heat transfer fluid (e.g., steam) from liquid-phase heat transfer fluid (e.g., condensate formed from the vapor-phase heat transfer fluid). A stream 1120 received from the wellbore 302 may be provided to the steam separator 1102. In some cases, all of stream 1118 is provided in stream 1120. In other cases, a fraction or none of stream 1118 is provided to the steam separator 1102. Instead, all or a portion of the stream 1118 may be provided as stream 1128 which may be provided to the first turbine set 1104 and/or to a high-pressure thermal process 1112 in stream 1129. The thermal process 1112 may be a thermochemical reaction requiring high temperatures and/or pressures (e.g., temperatures of between 500 and 2,000° F. and/or pressures of between 1,000 and 4,500 psig), such as the geothermally powered hydrogen production system 500. One or more valves (not shown for conciseness) may be used to control the direction of stream 1120 to the steam separator 1102, first turbine set 1104, and/or thermal process 1112. A vapor-phase stream 1122 of heat transfer fluid from the condenser may be sent to the first turbine set 1104 and/or the thermal process 1112 via stream 1126. A liquid-phase stream 1124 of heat transfer fluid from the steam separator 1102 may be provided back to the wellbore 302 and/or to condenser 742. The condenser 1142 is any appropriate type of condenser capable of condensing a vapor-phase fluid. The condenser 1142 may be coupled to a cooling or refrigeration unit, such as a cooling tower (not shown for conciseness).

The first turbine set 1104 includes one or more turbines 1106a,b. In the example of FIG. 11, the first turbine set includes two turbines 1106a,b. However, the first turbine set 1104 can include any appropriate number of turbines for a given need. The turbines 1106a,b may be any known or yet to be developed turbine for electricity generation. The first turbine set 1104 is connected to the steam separator 1102 and is configured to generate electricity from the vapor-phase heat transfer fluid (e.g., steam) received from the steam separator 1102 (vapor-phase stream 1122). A stream 1130 exits the first turbine set 1104. The stream 1130 may be provided to the condenser 1142 and then back to the wellbore 302. The condenser 1142 may be cooled using a heat driven chiller, such as an absorption chiller 1012 of FIG. 10, described below.

If the heat transfer fluid is at a sufficiently high temperature, as may be uniquely and more efficiently possible using the wellbore 302, a stream 1032 of vapor-phase heat transfer fluid may exit the first turbine set 1104. Stream 1132 may be provided to a second turbine set 1108 to generate additional electricity. The turbines 1110a,b of the second turbine set 1108 may be the same as or similar to turbines 1106a,b, described above.

All or a portion of stream 1132 may be sent as vapor-phase stream 1134 to a thermal process 1114. Process 1114 is generally a process requiring vapor-phase heat transfer fluid at or near the conditions of the heat transfer fluid exiting the first turbine set 1104. For example, the thermal process 1114 may include one or more thermochemical processes requiring steam or another heat transfer fluid at or near the temperature and pressure of stream 1132 (e.g., temperatures of between 250 and 1,500° F. and/or pressures of between 500 and 2,000 psig). The second turbine set 1108 may be referred to as “low pressure turbines” because they operate at a lower pressure than the first turbine set 1104. Fluid from the second turbine set 1108 is provided to the condenser 1142 via stream 1136 to be condensed and then sent back to the wellbore 302 via stream 1136.

An effluent stream 1138 from the second turbine set 1108 may be provided to one or more thermal processes 1116a,b. Thermal processes 1116a,b generally require less thermal energy than thermal processes 1112 and 1114, described above (e.g., processes 1116a,b may be performed temperatures of between 22° and 700° F. and/or pressures of between 15 and 120 psig). As an example, processes 1116a,b may include water distillation processes, heat-driven chilling processes, space heating processes, agriculture processes, aquaculture processes, and/or the like. For instance, an example heat-driven chiller process 1116a may be implemented using one or more heat driven chillers. Heat driven chillers can be implemented, for example, in data centers, crypto-currency mining facilities, or other locations in which undesirable amounts of heat are generated. Heat driven chillers, also conventionally referred to as absorption cooling systems, use heat to create chilled water. Heat driven chillers can be designed as direct-fired, indirect-fired, and heat-recovery units. When the effluent includes low pressure steam, indirect-fired units may be preferred. An effluent stream 1140 from all processes 1112, 1114, 1116a,b, may be provided back to the wellbore 302.

### Example Temperature Control System

FIG. 12 shows an example temperature control system 1200 of FIGS. 5, 7 and 9. The temperature control system 1200 is used to measure temperatures of system components (e.g., the electrolytic smelter 934) components and coordinate heating and cooling elements to maintain the desired temperatures. The temperature control system 1200 includes a temperature controller 1300, geothermally powered motors 1202, a heat transfer fluid conduit 1210, a heater 1212, a recirculating cooler 1214, an absorption chiller 1216, and a thermal exchange system 1218. The temperature control system 1200 may include more or fewer components than are shown in the example of FIG. 12. For example, a temperature control system 1200 used for heating alone may omit the recirculating cooler 1214 and the absorption chiller 1216. Similarly, a temperature control system 1200 that is used for cooling alone may omit the heater 1212. The ability to independently adjust the functions of heating and cooling by use of the temperature control system 1200 facilitates improved and more flexible response to fluctuating temperatures measured in system components. For example, a smelting process may necessitate a vessel to be maintained within an operational temperature range (i.e., a minimum temperature to drive an electrochemical reaction and a maximum temperature to curtail formation of byproducts). The temperature setpoint for such a vessel can be selected or adjusted to provide desired optimal temperatures. The temperature of the heat transfer fluid 404c used for heating or cooling the system component is modified as needed by the thermal exchange system 1218 by heating with heated thermal fluid 1204a or cooling with the cooled thermal fluid 1204b. The heat transfer fluid 404c is received by a heat transfer fluid input 1206 to be heated or cooled by the heat transfer fluid conduit 1210 which is heated or cooled by the coiled thermal fluid conduit 1220. The heat transfer fluid 404c is returned to the system component by a heat transfer fluid output 1208 at the desired temperature for heating or cooling the system component.

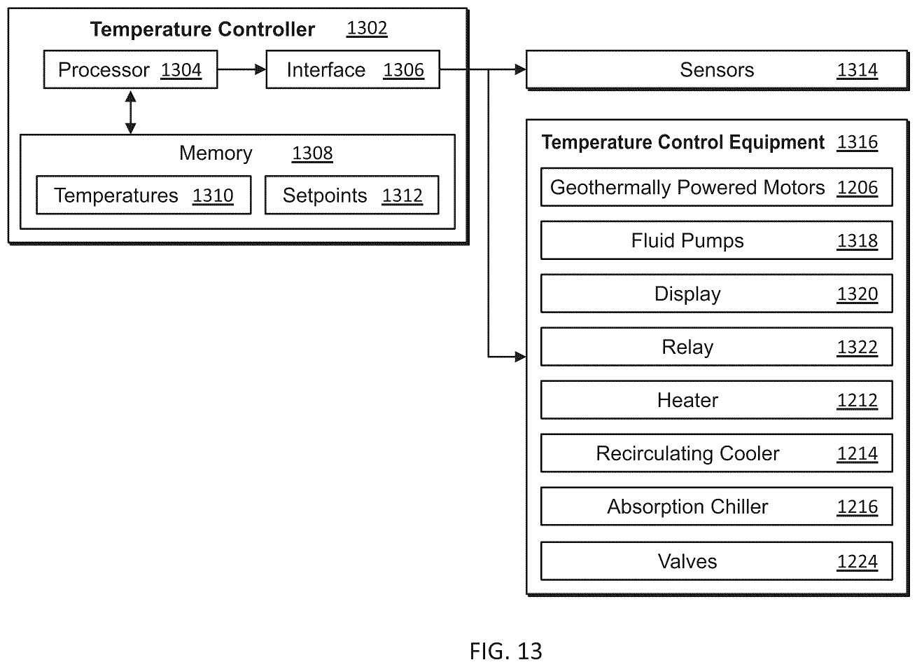

In the example of FIG. 12, the temperature of a system component (e.g., the electrolytic smelter 934) is measured by the temperature sensors 1314. Example temperature sensors 1314 are thermostats, thermistors, resistive temperature detectors, thermocouples, and semiconductor-based sensors. If the temperature measurement exceeds a heating setpoint, the temperature controller 1300 (see FIG. 13 and corresponding descriptions below) switches the heater 1212 off. As an example, a pump relay switch may be used in conjunction with fluid pumps to control flow of the heated thermal fluid 1204a from the recirculating cooler 1214 and the absorption chiller 1216 through a cooled thermal fluid input 1222 or from the heater 1212 through a heated thermal fluid input 1226 to cool or heat the coiled thermal fluid conduit 1220, respectively. If the temperature measurement exceeds a maximum threshold, the heater 1212 is shut off and the temperature controller 1300 switches the recirculating cooler 1214 on to begin cooling the coiled thermal fluid conduit 1220. If the temperature measurement exceeds a cooling setpoint, the temperature controller 1300 switches the recirculating cooler 1214 off. If the temperature measurement exceeds a minimum threshold, the recirculating cooler 1214 is shut off and the heater 1212 is turned on to begin heating the coiled thermal fluid conduit 1220. The flow of the cooled thermal fluid 1204b to the coiled thermal fluid conduit 1220 is controlled by a cooled thermal fluid valve 1224a. The flow of the heated thermal fluid 1204a to the coiled thermal fluid conduit 1220 is controlled by a heated thermal fluid valve 1224b.

The temperature control system 1200 can deliver high temperature heated heat transfer fluid 1228a via heat transfer fluid 404c in contact with a magma chamber or in contact with heat transfer fluid 404c heated by a magma chamber for operations that require heating. This ability to obtain high heat transfer allows deployment of alternative methods of heating during drying, smelting, and roasting compared to conventional fossil fuels. Geothermal heating can extract tin from lower grade ores using less energy consumption and producing lower CO₂ emissions, resulting in reduced economic loss and environmental impacts.

The temperature control system 1200 can deliver cooled heat transfer fluid 1228b via heat transfer fluid 404c routed by a recirculating cooler 1214 and cooled by an absorption chiller 1216 for operations that require cooling. Cooled heat transfer fluid 1228b can cool the heated thermal fluid 1204a in the coiled thermal fluid conduit 1220 by heat exchange with the recirculating cooler 1214. This ability to expedite the cooling process compared to passive cooling (i.e., allowing the system component to cool via turning off heating and waiting) can reduce waste generated as byproducts and hasten cooling to more quickly produce finished tin products leading to economic gains.

FIG. 13 illustrates an example temperature controller 1300 in greater detail. The example temperature controller 1300 includes a processor 1304, interface 1306, and memory 1308. The processor 1304 is electronic circuitry that coordinates operations of the temperature controller 1300. The processor 1304 may be a programmable logic device, a microcontroller, a microprocessor, or any suitable combination of these or similar components. The processor 1304 is communicatively coupled to the memory 1308 and interface 1306. The processor 1304 may be one or more processors. The processor 1304 may be implemented using hardware and/or software.

The interface 1306 enables wired and/or wireless communications of data or other signals between the temperature controller 1300 and other devices, systems, or domain(s), such as the temperature sensors 1314 and other temperature control equipment 1316. The temperature control equipment 1316 may correspond to any components of temperature control system 1300 illustrated in FIG. 13 or otherwise understood by a skilled person to be employed in mineral extraction operations. For example, the temperature control equipment 1316 may include one or more geothermally powered motors 1202 (e.g., to power fluid pumps 1318), fluid pumps 1318, and a display 1320 (e.g., an electronic display capable of displaying information determined by the temperature controller 1300). The interface 1306 is an electronic circuit that is configured to enable communication between these devices. For example, the interface 1306 may include one or more serial ports (e.g., USB ports or the like) and/or parallel ports (e.g., any type of multi-pin port) for facilitating this communication. As a further example, the interface 1306 may include a network interface such as a WIFI interface, a local area network (LAN) interface, a wide area network (WAN) interface, a modem, a switch, or a router. The processor 1304 may send and receive data using the interface 1306. For instance, the interface 1306 may send instructions to turn on the heater 1212 when a temperature measurement of a system component below the heating setpoint is detected. The interface 1306 may provide signals to cause a display 1320 to show an indication that a heating mode is being automatically implemented or should be implemented by an operator of a system component associated with the temperature controller 1300.

The memory 1308 stores any data, instructions, logic, rules, or code to execute the functions of the temperature controller 1300. For example, the memory 1308 may store monitored temperatures 1310, such as the temperature measured inside an electrolytic smelter 934, and setpoints 1312 that are compared to measured temperatures to determine operations. As described in more detail with respect to the various examples above, the monitored temperatures 1310 may be used to detect when the temperature of a system component has reached one of the setpoints 1310. For instance, if the monitored temperatures 1310 is detected by the temperature sensors 1314 as exceeding the range of the temperature in the setpoints 1312, the relay 1322 may be used to operate the heater 1212 or the recirculating cooler 1214. The memory 1308 may include one or more disks, tape drives, solid-state drives, and/or the like. The memory 1308 may store programs, instructions, and data that are read during program execution. The memory 1308 may be volatile or non-volatile and may comprise read-only memory (ROM), random-access memory (RAM), ternary content-addressable memory (TCAM), dynamic random-access memory (DRAM), and static random-access memory (SRAM).

### Example Method of Operating Temperature Control System

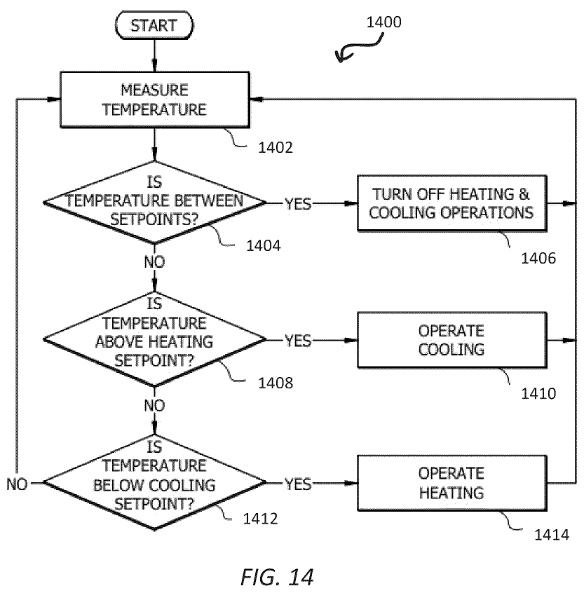

FIG. 14 illustrates an example method 1400 of operation of the temperature control system 1200. The method 1400 may begin at step 1402 where the temperature of a system component can be measured by use of the temperature sensors 1314. At step 1404, the temperature measured at step 1402 is stored as monitored temperatures 1310 and compared to the setpoints 1312, as described above with respect to the example of FIG. 13. If the monitored temperatures 1310 are determined to be within the range of temperatures in the setpoints 1312 (e.g., a cooling setpoint and a heating setpoint), operation proceeds to step 1406. At step 1406, all heating and cooling operations are turned off by using the relay 1322, then operations proceed to repeat step 1402 to measure the temperature of the system component by use of the temperature sensors 1314.

At step 1404, if the monitored temperatures 1310 are determined to be outside the range of temperatures in the setpoints 1312, operation proceeds to step 1408. If the monitored temperatures 1310 are determined to be exceeding the setpoints 1312 for heating, operation proceeds to step 1410. At step 1410, cooling operations (i.e., the recirculating cooler 1214 and the absorption chiller 1216) are turned on by using the relay 1322 or remain on, then operations proceed to repeat step 1402 to measure the temperature of the system component by use of the temperature sensors 1314.

At step 1408, if the monitored temperatures 1310 are determined to not be exceeding the setpoints 1312 for heating, operation proceeds to step 1412. If the monitored temperatures 1310 are determined to be exceeding the setpoints 1312 for cooling, operation proceeds to step 1414. At step 1414, cooling operations are turned off if they are on by the use of the relay 1322 and heating operations (i.e., the heater 1212) are turned on or remain on, then operations proceed to repeat step 1402 to measure the temperature of the system component by use of the temperature sensors 1314. If the monitored temperatures 1310 are determined to not be exceeding the setpoints 1312 for cooling, operation returns to step 1402 to repeat temperature measurement.

Modifications, omissions, or additions may be made to method 1400 depicted in FIG. 14. Method 1400 may include more, fewer, or other steps. For example, at least certain steps may be performed in parallel or in any suitable order. All or a portion of the operations may be performed by or facilitated using information determined using the temperature control system of FIG. 12. Any suitable temperature control equipment 1316 or associated component(s) may perform or may be used to perform one or more steps of the method 1400.

While the example systems of this disclosure are described as employing heating through thermal contact with a magma reservoir 214, it should be understood that this disclosure also encompasses similar systems in which another thermal reservoir or heat source is harnessed. For example, heat transfer fluid may be heated by underground water at an elevated temperature. As another example, heat transfer fluid may be heated by radioactive material emitting thermal energy underground or at or near the surface. As yet another example, heat transfer fluid may be heated by lava, for example, in a lava lake or other formation. As such, the magma reservoir 214 may be any thermal reservoir or heat source that is capable of heating heat transfer fluid to achieve desired properties (e.g., of temperature and pressure). Furthermore, the thermal reservoir or heat source may be naturally occurring or artificially created (e.g., by introducing heat underground that can be harnessed at a later time for energy generation or other thermal processes).

The geothermally powered systems of this disclosure may reduce waste in several ways. In addition to the advantages of the alternative equipment and/or methods described above, waste may further be reduced by the ability to process waste byproducts of the tin production system into useful secondary raw materials. Waste byproducts of metal refining often sit idle and contribute to pollution of local environments. The storage, disposal, and recycling of these byproducts, such as electric arc furnace dust, slag, and refractories is costly. The efficient and clean supply of energy from geothermal resources can power the processing of such wastes. Additionally, waste can be reduced by reducing carbon emissions from the electrolysis conventionally used during smelting. This process requires large amounts of electrical power. An estimated power consumption of (e.g., 2.8 kWh per kg of metal produced) presents challenges to the industry in terms of energy availability and cost and provides profit and environmental motivation to utilizing geothermal energy as presented in this disclosure. As described in this disclosure, geothermal energy can power tin production systems to produce less waste and less pollution (e.g., without using coal-fired processes or with a significant decrease in the use of such processes). As such, this disclosure may facilitate tin production with a decreased environmental impact and decreased use of costly materials.

Although embodiments of the disclosure have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. Moreover, items shown or discussed as coupled or directly coupled or communicating with each other may be indirectly coupled or communicating through some interface device, or intermediate component whether electrically, mechanically, fluidically, or otherwise.

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this disclosure has been particularly shown and described with reference to preferred or example embodiments, it will be understood by those skilled in the art that various changes in form and detail may be made therein without departing from the spirit and scope of the disclosure. Accordingly, this disclosure includes all modifications and equivalents of the subject matter recited in the claims appended hereto as permitted by applicable law. Changes, substitutions and alterations are ascertainable by one skilled in the art and could be made without departing from the spirit and scope disclosed herein. Moreover, any combination of the above-described elements in all possible variations thereof is encompassed by the disclosure unless otherwise indicated herein or otherwise clearly contradicted by context.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

What is claimed is:

1. A geothermally powered tin production system, comprising:
a geothermal system comprising a wellbore extending from a surface into an underground magma reservoir, the wellbore configured to heat a heat transfer fluid via heat transfer with the underground magma reservoir, thereby forming heated heat transfer fluid;
a scrubber configured to obtain ground tin oxide from a starting material (e.g., cassiterite ore), the scrubber comprising a fluid inlet configured to supply a wash liquid to the starting material and separate a washed tin oxide from other components of the starting material;
a dryer configured to heat a sorted tin oxide using the heated heat transfer fluid to remove water from a sorted tin oxide to form a dried tin oxide;
a separator configured to separate tailings from the dried tin oxide using the heated heat transfer fluid to produce a tin concentrate; and
a smelting furnace configured to heat the tin concentrate in the presence of heated air and smelting reagents to generate tin product, the smelting furnace comprising:
a vessel configured to receive the tin concentrate;
an air heater system configured to generate the heated air using the heated heat transfer fluid and provide the heated air to the vessel;
an inlet configured to provide the smelting reagents to the vessel; and
a heat exchanger coupled to the vessel and configured to heat the vessel using the heated heat transfer fluid.

2. The geothermally powered tin production system of claim 1, wherein the scrubber comprises a motor configured to facilitate filtering of the starting material to obtain the washed tin oxide, wherein the motor is powered at least in part by the heated heat transfer fluid and/or electricity generated using the heated heat transfer fluid.

3. The geothermally powered tin production system of claim 1, further comprising a sorter configured to sort the washed tin oxide by particle size, wherein the sorter comprises a motor coupled to a shaker configured to agitate the washed tin oxide in the sorter, wherein the motor is powered at least in part by the heated heat transfer fluid and/or electricity generated using the heated heat transfer fluid.

4. The geothermally powered tin production system of claim 1, wherein the dryer comprises a dryer heat exchanger configured to receive the heated heat transfer fluid and transfer heat from the heated heat transfer fluid to the sorted tin oxide.

5. The geothermally powered tin production system of claim 4, wherein the dryer further comprises a motor coupled to a dryer conveyor configured to move the dried tin oxide through the dryer, wherein the motor is powered at least in part by the heated heat transfer fluid and/or electricity generated using the heated heat transfer fluid.

6. The geothermally powered tin production system of claim 1, wherein the separator further comprises a motor coupled to a separator conveyor configured to move the sorted tin oxide through the dryer, wherein the motor is powered at least in part by the heated heat transfer fluid and/or electricity generated using the heated heat transfer fluid.

7. The geothermally powered tin production system of claim 6, wherein the separator further comprises an electromagnet powered at least in part by electricity generated using the heated heat transfer fluid.

8. The geothermally powered tin production system of claim 1, wherein the air heater system configured comprises an air compressor with a motor powered at least in part by the heated heat transfer fluid and/or electricity generated using the heated heat transfer fluid.

9. The geothermally powered tin production system of claim 1, further comprising one or both of an anode smelter and an electrolytic smelter, wherein the one or both of the anode smelter and the electrolytic smelter are coupled to a temperature control system configured to control a temperature of the anode smelter using the heated heat transfer fluid.

10. The geothermally powered tin production system of claim 9, wherein the temperature control system comprises:
a heat transfer fluid conduit comprising:
a heat transfer fluid inlet for receiving heat transfer fluid from an electrolytic smelter heat exchanger of the anode smelter and/or the electrolytic smelter; and
a heat transfer fluid outlet for providing temperature-controlled heat transfer fluid back to the electrolytic smelter heat exchanger;
a thermal exchange system comprising:
a coiled thermal fluid conduit contacting the fluid conduit;
a cooled thermal fluid valve in a cooled thermal fluid input coupled to the coiled thermal fluid conduit, wherein the cooled thermal fluid input is coupled to a recirculating cooler operable to be cooled by an absorption chiller powered by the heated heat transfer fluid; and
a heated thermal fluid valve in a heated thermal fluid input coupled to the coiled thermal fluid conduit, wherein the heated thermal fluid input is coupled to a heater operable to be heated by the heated heat transfer fluid; and
a temperature controller comprising a processor and an interface communicatively coupled to the cooled thermal fluid valve and the heated thermal fluid valve, wherein the processor is configured to:
cause the cooled thermal fluid valve to open and the heated thermal fluid valve to close when a temperature of the electrolytic smelter heat exchanger is greater than a temperature setpoint, thereby allowing cooled thermal fluid to flow through the coiled thermal fluid conduit and cool, such that the temperature-controlled heat transfer fluid is cooled; and
cause the heated thermal fluid valve to open and the cooled thermal fluid valve to close when the temperature of the electrolytic smelter heat exchanger is less than the temperature setpoint, thereby allowing heated thermal fluid to flow through the coiled thermal fluid conduit, such that the temperature-controlled heat transfer fluid is heated.

11. A method, comprising:
heating a heat transfer fluid via heat transfer with an underground magma reservoir, thereby forming heated heat transfer fluid;
obtaining, using a scrubber, a washed tin oxide from a starting material, by contacting a wash liquid to the starting material to separate the washed tin oxide from other components of the starting material;
heating a sorted tin oxide formed from the washed tin oxide, wherein the sorted tin oxide is heated using the heated heat transfer fluid to remove water from a sorted tin oxide and form a dried tin oxide;
separating tailings from the dried tin oxide to produce a tin concentrate; and
heating, in a geothermally heated smelting furnace, the tin concentrate in the presence of heated air and smelting reagents to generate tin by:
receiving the tin concentrate in a vessel;
generating the heated air using the heated heat transfer fluid;
providing the heated air to the vessel;
providing the smelting reagents to the vessel; and
heating the vessel using the heated heat transfer fluid.

12. The method of claim 11, wherein obtaining the washed tin oxide further comprises filtering the starting material using a motor powered at least in part by the heated heat transfer fluid and/or electricity generated using the heated heat transfer fluid.

13. The method of claim 11, further comprising forming the sorted tin oxide by sorting the washed tin oxide by particle size using a motor coupled to a shaker configured to agitate the washed tin oxide in a sorter, wherein the motor is powered at least in part by the heated heat transfer fluid and/or electricity generated using the heated heat transfer fluid.

14. The method of claim 11, further comprising heating the sorted tin oxide using a heat exchanger configured to receive the heated heat transfer fluid and transfer heat from the heated heat transfer fluid to the sorted tin oxide.

15. The method of claim 14, further comprising moving the dried tin oxide through a dryer in which the dried tin oxide is heated using a motor powered at least in part by the heated heat transfer fluid and/or electricity generated using the heated heat transfer fluid.

16. The method of claim 11, further comprising separating the sorted tin oxide from the dried tin oxide precursor using a motor powered at least in part by the heated heat transfer fluid and/or electricity generated using the heated heat transfer fluid.

17. The method of claim 16, further comprising separating tailings from the dried tin oxide using an electromagnet powered by at least in part by electricity generated using the heated heat transfer fluid.

18. The method of claim 11, further comprising generating the heated air using an air compressor with a motor powered at least in part by the heated heat transfer fluid and/or electricity generated using the heated heat transfer fluid.

19. The method of claim 11, further comprising using one or both of an anode smelter and an electrolytic smelter to further refine the tin concentrate, wherein the one or both of the anode smelter and the electrolytic smelter are coupled to a temperature control system configured to control a temperature of the anode smelter using the heated heat transfer fluid.

20. A geothermally powered tin production system, comprising:
a scrubber configured to obtain ground tin oxide from a starting material, the scrubber comprising a fluid inlet configured to supply a wash liquid to the starting material and separate the tin oxide from other components of the starting material;
a dryer configured to heat a sorted tin oxide formed from the tin oxide separated from the other components, the sorted tin oxide heated using a heated heat transfer fluid to remove water from the sorted tin oxide to form a dried tin oxide, wherein the heated heat transfer fluid is received from a geothermal system comprising a wellbore extending from a surface into an underground magma reservoir, the wellbore configured to heat a heat transfer fluid via heat transfer with the underground magma reservoir to form the heated heat transfer fluid;
a separator configured to separate tailings from the dried tin oxide to produce a tin concentrate; and
a smelting furnace configured to heat the tin concentrate in the presence of heated air and smelting reagents to generate tin product, the smelting furnace comprising:
a vessel configured to receive the tin concentrate;
an air heater system configured to generate the heated air using the heated heat transfer fluid and provide the heated air to the vessel;
an inlet configured to provide the smelting reagents to the vessel; and
a heat exchanger coupled to the vessel and configured to heat the vessel using the heated heat transfer fluid.
